(19) United States
(12) Patent Application Publication
(10) Pub. No.: US 2022/0143650 A1
(43) Pub. Date: May 12, 2022

(54) BEVERAGE CANS WITH SURFACE OBSCURING COATINGS

(71) Applicant: Contour Printworks, LLC, Longmont, CO (US)

(72) Inventors: Timothy L. Feaver, Louisville, CO (US); Matthew E. Arveson, Boulder, CO (US); James Remnant, Boulder, CO (US); Alan W. Teague, Westminster, CO (US); Jason S. Paulman, Fort Collins, CO (US); James Rudolph, Boulder, CO (US); Robert Wayne Moore, Salina, KS (US)

(21) Appl. No.: 17/487,812

(22) Filed: Sep. 28, 2021

Related U.S. Application Data
(60) Provisional application No. 63/085,486, filed on Sep. 30, 2020.

(51) Int. Cl. B05D 7/00; B65D 25/34; B05D 3/02; B05D 3/06; B41M 5/00; B41M 7/00

(52) U.S. Cl. CPC B05D 7/586; B65D 25/34; B05D 3/0272; B41M 7/0054; B41M 5/0047; B41M 5/0011; B41M 5/0088; B05D 3/067

(57) ABSTRACT

This disclosure describes systems, methods, and apparatus for decorating a can comprising a base, a curvilinear side surface extending in an upward direction from the base and comprising a neck and flanged portion, wherein the base and curvilinear side surface are formed using a metallic material, and at least one layer each of a first ink and a first overvarnish applied on at least a portion of the curvilinear side surface. The method further comprises surface treating the curvilinear side surface to increase a surface energy of the first overvarnish, applying one or more layers of an obscurant coating to the portion of the curvilinear side surface, wherein the portion may or may not include the neck and flanged portion, applying one or more layers of a second overvarnish and/or second ink to the portion of the curvilinear surface of the can, and curing the can.

### CROSS-REFERENCE TO RELATED APPLICATIONS

The present Application for Patent claims priority to U.S. Provisional application No. 63/085,486 filed on Sep. 30, 2020 and is also related to U.S. Non-Provisional application Ser. No. 16/938,659 titled “Surface Treatment for Preformed Necked Cans” filed Jul. 24, 2020 and assigned to the assignee hereof. The details of these applications are hereby expressly incorporated by reference herein for all proper purposes.

### FIELD OF THE DISCLOSURE

The present disclosed embodiments relate generally to systems and methods for obscuring the decorations on previously decorated aluminum cans, and in some cases to apply a new decoration on top of the obscuring coating. In particular, but not by way of limitation, the present disclosed embodiments relate to coating cans and, in some cases, printing and varnishing those cans.

### DESCRIPTION OF RELATED ART

Cans are ubiquitous in the food and beverage industry. In some cases, cans may be printed or decorated by can makers as part of the can manufacturing process. In most cases, cans are preformed necked/flanged cans that have been decorated with color or graphical elements and overvarnished with a protectant layer containing lubricants, which may allow the can to be easily conveyed during the filling and packing process without sticking to other cans or equipment. In some cases, such cans are sold as undecorated preformed necked/flanged “brite” cans comprising none or at least one overvarnish layer. Current techniques for decorating (e.g., printing) the necked/flanged portions of such “brite” cans are lacking for a variety of reasons, including operating economics and cost, as well as health and safety considerations. In many other cases, decorated necked and flanged cans may be unusable for a variety of reasons, such as customer cancellations or misprints. In these cases, cans that are perfectly good from a functional perspective must be either discarded or recycled, leading to extra costs and lost revenue opportunities for both the can manufacturers and their customers.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below. For the purposes of this disclosure, the terms can, beverage can, container, and preformed can may be used interchangeably throughout the application. Further, for the purposes of this disclosure, the term surface treating device may be equivalent to the term surface treatment machine or surface treatment system, including machines or systems that apply a primer or other adhesion-improving coatings. Spray or spraying device may also refer to an overvarnish spraying system or to a digital printing device. The term obscurant may refer to any material that is optically dense, usually containing pigments, in the form of either a bulk liquid, solid or slurry, or a coating made from the same, and may refer to inks and paints that may serve the dual purpose of both obscuring and decorating the underlying surface, as well as other varnishes, basecoats, and overvarnishes, any of which may also contain lubricants that may be used as a protective coating on beverage cans. The term obscurant may also refer to a coating consisting of multiple coats applied consecutively, in which at least one coating application is followed by a curing period, which may or may not include forced air, heat, UV energy, electron beam energy, or some other means to accelerate curing, prior to application of a subsequent coating layer. Decoration may refer to the process or result of a process that creates an image, text or other graphical elements on at least a portion of a can, in which such image, text or other graphical elements may or may not act as the sole obscurant layer on a can. Curing oven may also refer to a UV energy source, an electron beam energy source, or any other source of energy or device used to cure coating materials. Lastly, the term printing device may refer to a printer for applying ink (e.g. as an obscurant and/or a decoration) and/or a dedicated obscurant coating to cans, such as an inkjet printer with or without UV-curing capabilities, or to any other device that applies paint or ink via a roller, sprayer or other mechanism.

Currently, there are various means for decorating cans, particularly two-piece cans suitable for beverages and other products intended to be consumed directly from the can. For example, beverage cans may be printed by a can maker as part of the can manufacturing process. In conventional techniques, can makers typically use a traditional solvent-based offset printing process with four or more colors and transfer rollers to decorate a bare aluminum elongated cup with straight sides. After the printing process, a clear overvarnish containing waxes and/or other lubricants is typically applied with rollers similar to the transfer rollers. The overvarnish is then thermally cured in an oven, following which the can proceeds to a necking machine, which uses a series of successively smaller stamping dies to form the neck of the can. In some cases, the lubricants in the overvarnish enable the can to be necked without damaging the underlying ink. After necking, the top of the can may be flanged. In some cases, the flange may subsequently be used to seal a lid on the can in a seaming process. In some circumstances, the seaming process may be performed after the can has been filled. These formed cans, once printed, necked and flanged in the form required by beverage customers, cannot be reprinted, or redecorated, using the same printing equipment used for the original decoration. As a result, printed formed cans that are printed in excess or in error for some reason, or “orphan” cans, are typically discarded or crushed, baled and sent back to an aluminum recycler to be melted down and converted into new aluminum cans.

Conventionally, “brite” cans are cans that have gone through the above described process, including overvarnish application and curing followed by necking and flanging, with the exception that no ink is applied to the metal can prior to the application of the overvarnish.

In another conventionally used technique, a shrink-wrapped plastic sleeve may be applied onto a preformed “brite” can. A white or clear plastic film may be printed using either digital or conventional solvent printing processes and then turned into a sleeve. This sleeve may be slipped over the can with the aid of a varnish or special lubricating ink. Further, the sleeve-can assembly may be heated, causing the plastic sleeve to shrink and fit on to the can. Currently, the majority of cans used for beverages sold in smaller quantities (or volumes), such as craft beers, are such plastic-sleeved cans. However, due to their reliance on materials derived from petrochemicals, as well as the use of human sorters for removing the cans from the stream of plastic products during the recycling process, such plastic-sleeved cans are generally considered to be environmentally unfriendly. In some cases, plastic from the sleeves is also chemically dissolved or burned off as part of the aluminum remelting process, and may lead to harmful chemicals being released into the environment. Environmental issues aside, plastic sleeves are often perceived to be of inferior quality to traditionally printed cans. Thus, there is a need for means to blank out or obscure the original decorations on orphan cans so that they may be redecorated and reused, rather than discarded or recycled. While a shrink-wrapped plastic sleeve or an adhesive label may functionally obscure the original decoration, there are practical limitations to the use of these techniques. First, packaging companies that use repurposed or “upcycled” cans are likely to be hesitant to purchase them if their customers can readily remove the sleeve or label and discover that the can was originally decorated for another packaging company. Likewise, disclosure of the original decoration to the consumer may also create concerns for the packaging company for which the can was originally decorated. Additionally, the use of repurposed cans has legal ramifications when they are intended to be used, for instance, to package alcoholic beverages. It may be illegal to package an alcoholic beverage in a redecorated can that was previously labeled for a different beverage if it is possible to remove the redecorated label or sleeve, thereby causing the beverage to be packaged in a mislabeled can.

More recently, digital printers have been developed to print directly onto straight-walled beverage can blanks (i.e., prior to necking and flanging) that have not yet been varnished. In some cases, these printers may be installed as part of a can making line, and may be used as an alternative to the traditional printing process or as a means to augment the traditional printing process. However, the practicality of using such printers to decorate straight-walled beverage can blanks is questionable. Currently, the fastest digital printers operate at less than a tenth the speed of the slowest traditional can decorators, which may be unacceptable to many can makers who are used to printing large volumes of cans. While some outside parties, such as beverage producers, print on straight-walled beverage can blanks, a majority of can makers do not commercially sell cans that have not been necked and flanged (i.e., preformed). Additionally, it is atypical for can makers to sell cans without an applied overvarnish, since overvarnish application is considered to be an important part of the can fabrication process.

Can makers often find it disruptive to remove straight-walled can blanks from the middle of the production process, since the straight-walled can blanks (i.e., cans that have not yet been necked and flanged) are relatively flimsy and easily damaged. Thus, there is need for a technique for printing on preformed, necked and overvarnished cans, including those that can be purchased in bulk directly from the can makers or other sources. In some circumstances, “direct-to-shape,” or “direct-to-object” printers may be adapted with suitable fixturing to print on such cans. In some cases, these printers may use inkjet printheads, where each printhead may contain one or more rows of nozzles, where each row is typically dedicated to a single color of ink. Further, these printers may be configured to dispense ink onto a can that is rotated adjacent to the printhead. In some cases, the printer may also apply a clear overvarnish to cover the one or more underlying ink layers. In other cases, printers using certain ink chemistries or printer technologies may find it difficult or impossible to achieve good coating results on some preformed cans, due to incompatibility with the inks and/or overvarnishes originally applied to the cans by the can maker. In particular, some printers may be limited to printing on cans that already have a white “basecoat” layer, or to cans that are supplied by a specific can manufacturer or use a specific overvarnish. These printers may require that the preformed cans to be printed on first be treated with a coating that is compatible with the printer and ink being used, so as to expand their selection of cans on which to print. These printers thus may benefit from the use of an obscurant that also acts as a primer to improve the adhesion of subsequently applied layers. Inkjet technologies can be classified into two main types: continuous inkjet (CIJ) and drop-on-demand (DOD). Further, piezoelectric and thermal inkjet are some examples of DOD inkjet technologies.

For this reason, there is a need for a process to obscure the original decoration over all or a portion of the entire curvilinear side surface of the decorated can including the neck, in a way that reduces the likelihood for the packager that is reusing the can, or for the consumer, to uncover and reveal all or a significant part of the original decoration. Further, there is a need for a process for applying a second decoration (e.g., a digitally printed ink layer) that may be used as the obscurant layer, or in addition to the obscurant layer, and a water-based overvarnish that may protect the ink and/or the obscurant coatings and also facilitate in providing a can surface with adequate “slip” necessary for the can to pass through a typical automated can filling and processing manufacturing line (i.e., without sticking to other cans and/or equipment which may cause interruptions in the process). In some cases, an obscurant coating consisting of a pigmented water-based basecoat (traditionally used underneath decorations applied to the can and here used as an overcoat) or a pigmented water-based overvarnish may be utilized, which may serve to both obscure the original decoration as well as provide a suitable can surface. In some cases, such as when a packager does not secure orphan cans from another source, but instead, wishes to reuse their own orphan cans (i.e., rather than discard or recycle them) by choosing to have the cans overprinted, as by a digital direct-to-shape printer, it may not be necessary to completely obscure the original decoration with another obscurant layer before applying the overprinted layer (e.g., digitally printed ink layer). In these cases, it may be acceptable to use the digitally printed ink layer as the sole obscurant, or to use a pre-applied obscurant layer underneath the overprinted layer such that a portion of the original decoration shows through the pre-applied obscurant coating, as long as the portion showing through is not enough to significantly disrupt or distract from the second decoration applied to the pre-applied obscurant coating.

One method of applying an overvarnish for protecting underlying coatings and providing sufficient slip may involve the use of ultra-violet cured overvarnishes containing photoinitiators. These may be applied to a can, following which the can is exposed to an UV lamp. Exposure to UV radiation may cause the overvarnish to cure and harden in a very short period (e.g., 10 milliseconds (ms), 50 ms, 100 ms, etc.). While use of UV-cured overvarnishes may be seen as a convenient option for protecting the underlying ink, questions exist about potentially negative impacts on health that may arise when the lips, tongue or hands make contact with UV-cured coatings, particularly ones in which coatings are not fully cured. For instance, in some cases, uncured monomers and oligomers, as well as excess photoinitiator agents in the coatings, may migrate to the surface of the can and cause allergic reactions, if not more substantial bodily harm. For this reason, water soluble overvarnishes that are not UV cured may be used instead. In some cases, water soluble overvarnishes may be used for commercially available printed beverage cans intended for direct consumption.

The present disclosure includes systems, methods, materials and apparatuses for a surface treatment for a preformed decorated necked can that enables the outer surface of the can's overvarnish base, which may have been applied previously by the can maker, to have a high surface energy relative to that of the obscurant coatings (either a dedicated obscurant layer or an ink layer applied for obscuring and decorating) to be applied so as to support good adhesion of the obscurant layer onto the overvarnish base. After the application of the obscurant layer, the resulting can may contain a continuous or non-continuous obscurant layer covering all or a portion of the underlying decoration, which may then be coated with a second obscuring/decorating layer and/or a second water-soluble overvarnish so that the obscurant layers and both layers of overvarnish may potentially extend over the entire curvilinear side surface of the can (i.e., from the bottom of the can wall to the flange at the top of the can's neck). In other embodiments one or more of the overvarnishes may be used as a primer over the top of a plasma-treated can to allow the obscurant to wet out and cover the underlying graphics with less material and fewer coats.

Some embodiments of the disclosure may be characterized as a method for obscuring all or a portion of the decorations on a previously overvarnished can, the method comprising: providing a can, the can comprising a base, a curvilinear side surface, the curvilinear side surface extending in an upward direction from the base and comprising a neck and flanged portion, and wherein the base and curvilinear side surface are formed using a metallic material, and at least one layer of ink applied on at least the curvilinear side surface, as well as at least one layer of a first overvarnish applied on at least the curvilinear side surface. The method further comprises optionally surface treating the curvilinear side surface of the can to increase a surface energy of the at least one layer of the first overvarnish, applying one or more layers of an obscurant coating and/or an obscurant/decorating coating to a portion of the curvilinear side surface of the can, optionally applying one or more layers of a second overvarnish to the portion of the curvilinear side surface of the can, and curing, via a curing oven, the can.

Other embodiments of the disclosure may also be characterized as a beverage can comprising a base, a curvilinear side surface extending in an upward direction from the base, the curvilinear side surface comprising a neck and flanged portion, and wherein the base and curvilinear side surface are formed using a metallic material, one or more layers of ink forming a decoration on the curvilinear side surface, and a first overvarnish layer overlying the ink and formed on at least the curvilinear side surface. The beverage can further comprises one or more layers of an obscurant coating, which may be both an obscurant and a decoration layer, formed on at least a portion of the curvilinear side surface, which may or may not include the neck and flanged portion. In some embodiments, the one or more layers of obscurant coating may be formed after surface treating the curvilinear side surface of the can, wherein the surface treating causes an increase in surface energy of the first overvarnish layer. In some embodiments, the beverage can may also comprise one or more layers of ink forming a second decoration over the dedicated obscurant layer on at least a portion of the curvilinear side surface. In some embodiments, the beverage can may comprise one or more layers of a second overvarnish formed on at least the curvilinear side surface, wherein forming the one or more layers of the second overvarnish includes curing the one or more layers of the second overvarnish via a curing oven.

Other embodiments of the disclosure can be characterized as a system for obscuring all or a portion of the decorations on a previously decorated and overvarnished can, the system comprising: the can, wherein the can comprises a base, a curvilinear side surface, the curvilinear side surface extending in an upward direction from the base and comprising a neck and flanged portion, and wherein the base and curvilinear side surface are formed using a metallic material, one or more layers of ink forming a first decoration on the curvilinear side surface, and at least one layer of a first overvarnish applied on at least the curvilinear side surface. The system further comprises a printing or spraying device for applying the obscurant coating and a curing oven for curing the obscurant coating. In some embodiments, the system also comprises a surface treatment device to increase the surface energy of the first overvarnish layer prior to applying the obscurant layer. In some embodiments, the system includes a direct-to-shape printer, such as a digital inkjet printer, to apply one or more layers of ink as either a dedicated obscurant layer or as a second decoration over the obscurant layer. In some embodiments, the system also comprises a second spraying device for applying a second water-soluble overvarnish as the outer layer of the can. In some embodiments, the system also comprises a third spraying device as the surface treatment device, used to apply a water-soluble primer, varnish or other material to increase the surface energy of the first overvarnish layer prior to applying the obscurant layer. In some embodiments, the system also comprises a controller or one or more hardware processors configured by machine-readable instructions to perform some or all of the following operations: surface treat, by the surface treatment device, at least the curvilinear side surface of the can to increase a surface energy of the at least one layer of the first overvarnish; apply, by the spraying or printing device, one or more layers of an obscurant coating to a portion of the curvilinear side surface of the can; cure, by the curing oven, the one or more layers of the obscurant; apply, by the printing device, one or more layers of ink to a portion of the curvilinear side surface of the can; apply, by the spraying or printing device, one or more layers of a second overvarnish to the curvilinear side surface of the can; and cure, by the curing oven or other energy source, the one or more layers of the second overvarnish.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 is an illustration of a process flow for applying an obscurant coating to previously decorated beverage cans according to an embodiment of the disclosure.

FIGS. 2A, 2B, 2C, and 2D illustrate a blown ion surface treatment system for surface treating preformed necked cans according to an embodiment of the disclosure.

FIG. 3 illustrates a laser surface treatment system for surface treating preformed necked cans according to an embodiment of the disclosure.

FIGS. 4A and 4B illustrate an embodiment of a system for curing preformed necked cans in accordance with one or more implementations.

FIGS. 5A, 5B, and 5C illustrate an alternate embodiment of a system for curing preformed necked cans in accordance with one or more implementations.

FIG. 6 illustrates a method for surface treating and applying an obscurant coating to previously decorated preformed necked cans according to an embodiment of the disclosure.

FIG. 7 is a block diagram depicting physical components that may be utilized to realize a controller according to an embodiment of the disclosure.

### DETAILED DESCRIPTION

The present disclosure relates generally to decorating beverage cans by applying an obscurant (or obscuring) coating to previously decorated beverage cans. More specifically, but without limitation, the present disclosure relates to surface treating, painting, and overvarnishing beverage cans.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods, and computer program products according to various embodiments of the present invention. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

As previously described, there exists a need for a refined process for repurposing, or upcycling, previously printed or decorated cans (e.g., food safe cans, beverage cans, etc.) so as to conceal some or all of their original decoration in a manner that creates a new decoration directly or allows a new decoration to be applied to the can so that it may be reused for packaging (i.e., rather than being discarded or recycled). In one embodiment, a previously printed necked and flanged can may be overprinted directly on using the techniques described herein.

It should be noted that, lubricants used in the first (or original) overvarnish and food-grade lubricants applied to cans as part of the necking process may significantly lower the surface energy of the cans, which may in turn make it difficult for obscurant coatings (e.g., liquid inks) to wet onto their surface and adhere properly. In order to enable good adhesion of an obscurant coating layer onto the overvarnish base, a herein disclosed surface treatment may be applied to the can, giving it a high surface energy relative to that of the obscurant coating to be applied.

Broadly, this disclosure describes systems, methods, and apparatus for fully or partially concealing the color and graphical elements of a previously decorated can so that it may be redecorated by any of the various means described herein. In some embodiments, the can comprises a base, a curvilinear side surface extending in an upward direction from the base and comprising a neck and flanged portion, wherein the base and curvilinear side surface are formed using a metallic material, at least one layer each of a first overvarnish and a first ink applied on at least a portion of the curvilinear side surface, and one or more layers of an obscurant coating formed on at least the portion of the curvilinear side surface such that the one or more layers of the obscurant coating partially or fully obscure at least a portion of the color, text or graphical elements of the underlying first ink layer and reduce or eliminate the legibility of the same.

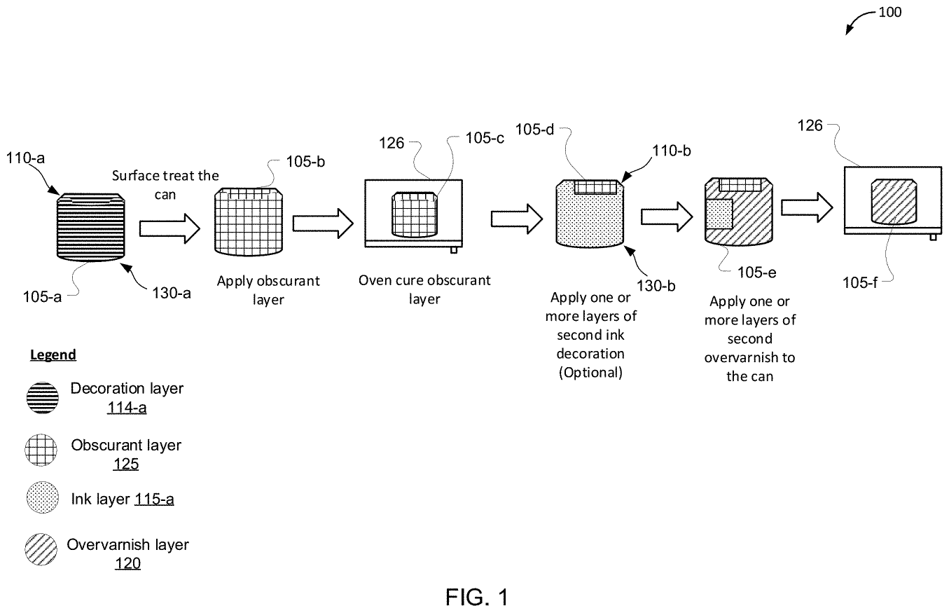

FIG. 1 is an illustration of a process flow 100 for surface treating and applying an obscurant coating to previously decorated preformed necked cans according to an embodiment of the disclosure. In some cases, process flow 100 may relate to surface treating and coating a can 105 with an obscurant layer. In some cases, process flow 100 may relate to surface treating a can 105, coating it with an obscuring layer, optionally decorating it, and then optionally coating it with a water-soluble overvarnish layer. In other cases, process flow 100 may relate to treating a can 105 with an obscurant layer. In still other cases, process flow 100 may relate to treating a can 105 with an obscurant layer created by applying multiple obscurant layers, at least the first of which is followed by a curing period, which may or may not be equal in length to other curing periods, and which may or may not employ forced air, heat, UV energy, or any other curing accelerant. The can may or may not be surface treated prior to application of the obscurant layer. Further, process flow 100 may or may not include decorating the can, and any decoration may consist of a combined obscuration/decoration step or a decoration step paired with a dedicated obscuration step. In some embodiments, a second water-soluble overvarnish layer may be used to coat all or at least a portion of the can (e.g., portion comprising the obscuring layer). As shown in process flow 100, can 105 may be referred using different reference numerals (e.g., can 105-a, can 105-b, can 105-c, can 105-d, and can 105-e) based on the step or process it is in.

In some cases, can 105-a may be an example of a previously decorated, necked, and flanged can. As shown, can 105-a comprises a neck 110-a and a base 130-a. In some cases, the can 105-a may comprise a curvilinear profile containing both curved and linear segments. In some embodiments, a can manufacturer may apply one or more layers of a first decoration layer 114-a to the entire curvilinear surface (e.g., side surface, neck 110-a, base 130-a, etc.) of the can 105-a, where the first decoration layer 114-a may comprise a first ink decoration layer as well as one or more layers of a first overvarnish. In some cases, the first overvarnish may be an example of a water-soluble overvarnish, or alternatively a UV-cured or electron-beam cured overvarnish. It should be noted that, applying the one or more layers of the first overvarnish may be an optional step in process flow 100.

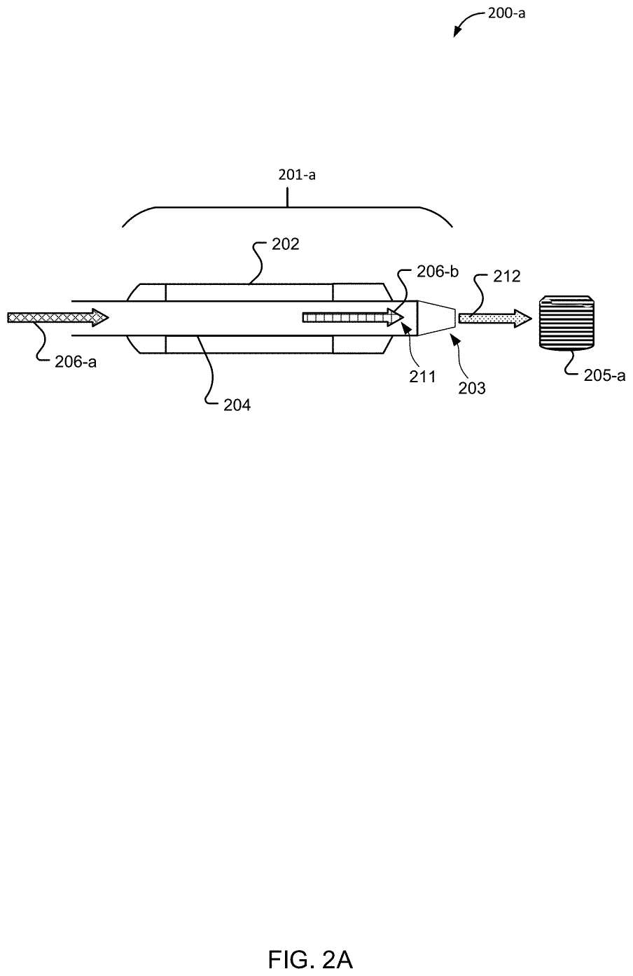

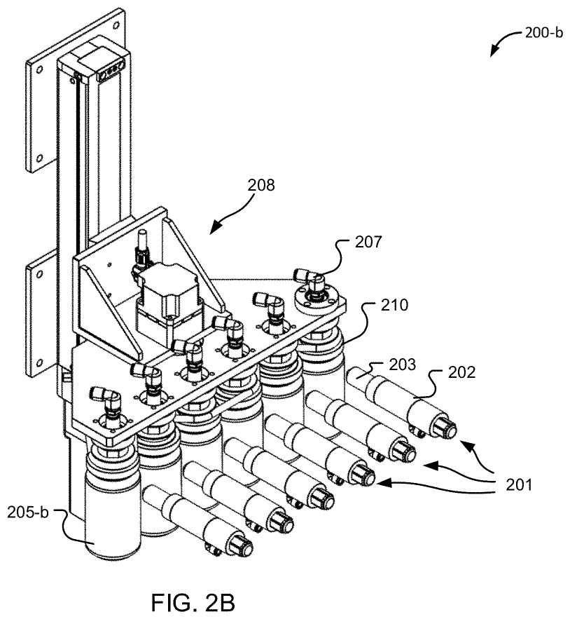

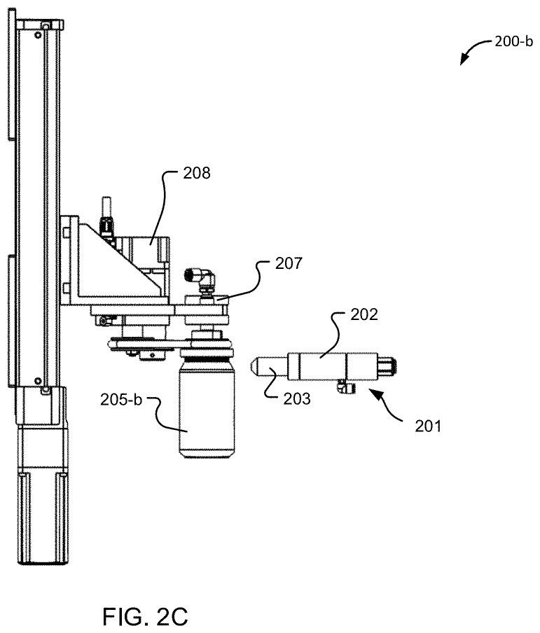

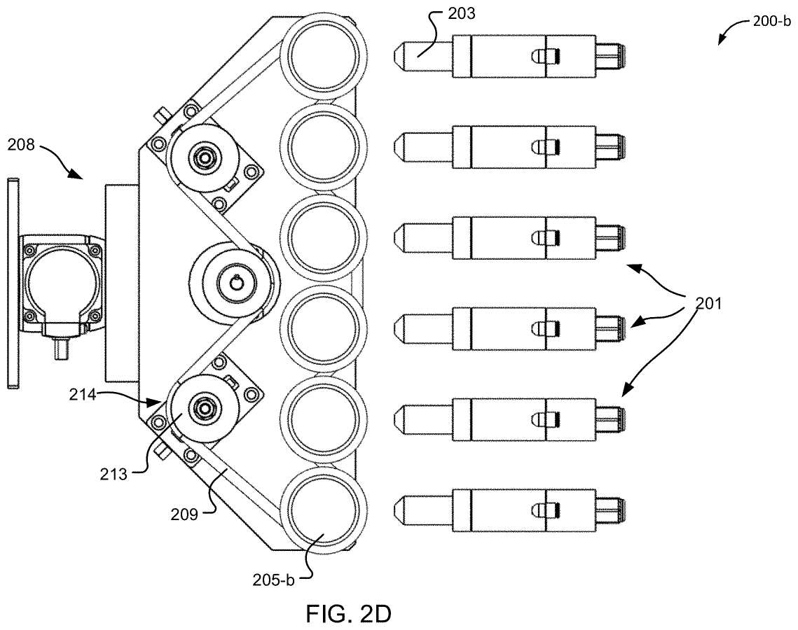

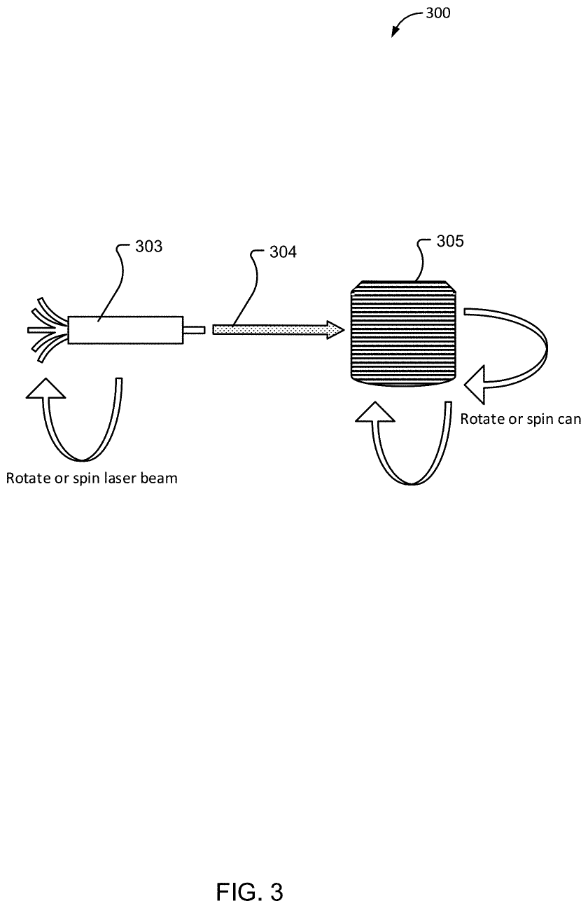

Following application of one or more layers of the first overvarnish, at least a portion of the curvilinear side surface of the can 105-a may be surface treated to increase the surface energy of the overvarnish coating, as well as any lubricant that may have contaminated the neck of the can, further described in relation to FIGS. 2A-D and 3. In some cases, surface treating may allow the can surface to “wet out” inks and/or obscurant coatings, which may serve to enhance appearance and optimize adhesion. In some embodiments, the surface treatment may include blown ion plasma treatment (described in relation to FIGS. 2A-D), laser surface treatment (described in relation to FIG. 3), detergent washing, corona treatment, chemical etching, chemical plasma treatment, flame treatment, and/or application of primer materials, including varnishes and overvarnishes, to name a few non-limiting examples. In some cases, applied primers, varnishes or other materials may require a thermal cure involving dwell time at an elevated temperature (e.g., in a curing oven) as part of the surface treatment process. Such thermal cure may take place prior to subsequent coating steps. In some cases, the use of multiple surface treatment techniques (e.g., blown ion plasma treatment and laser surface treatment) may be contemplated, for instance, to emulate and enhance the action and performance of a single surface treatment system. In some cases, the laser surface treatment or other surface treatment method may permanently remove the ink layer and the first overvarnish layer, which may allow subsequent coatings to be deposited directly on the aluminum can or another coating on which the first decoration (i.e., first ink layer) was originally printed.

In some cases, following surface treatment, one or more layers of an obscurant coating (i.e., obscurant layer 125) may be applied to the overvarnished and surface treated can 105-a, now represented as can 105-b. In some embodiments, the one or more layers of obscurant coating may be applied to the entire curvilinear side surface of the can, including neck and flange portions, as well as the base. In other cases, the one or more layers of obscurant may be applied to only a portion of the curvilinear side surface, for instance, based on design elements in the first decoration layer 114-a and the desire to obscure those elements or not. In either case, surface treating the entire curvilinear side surface of the can may allow obscurant to be applied from the base to the top (necked) portion of the can 105-b. As shown, can 105-b comprises one or more layers of obscurant coating applied on its neck, as well as its side surface. In some cases, obscurant coating may also be applied to a base of can 105-b. In other cases, obscurant layer 125 may be applied directly to all or a portion of the curvilinear side surface of can 105-b, without first performing the surface treatment process.

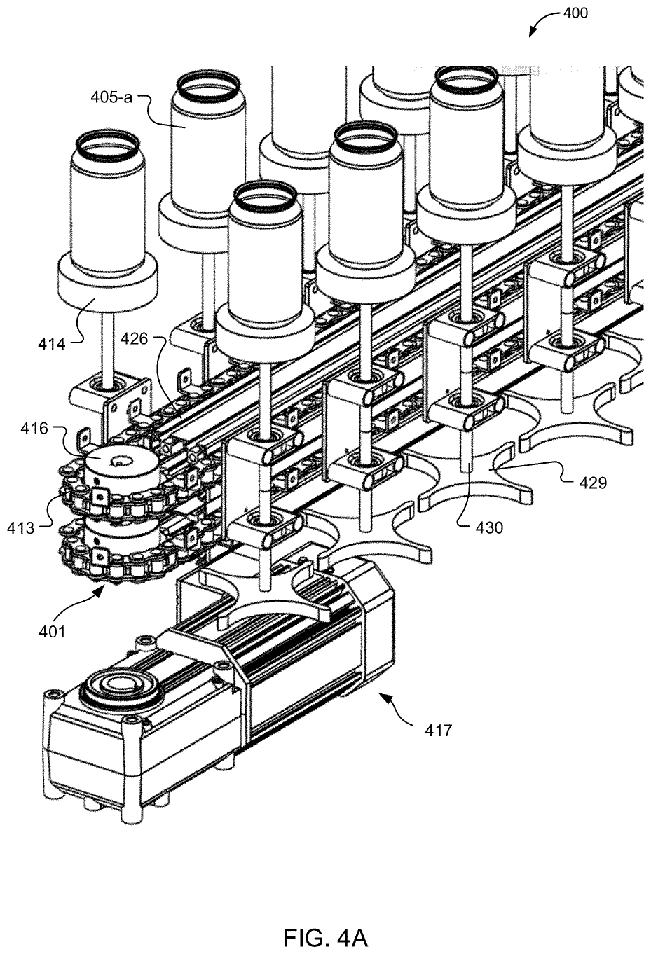

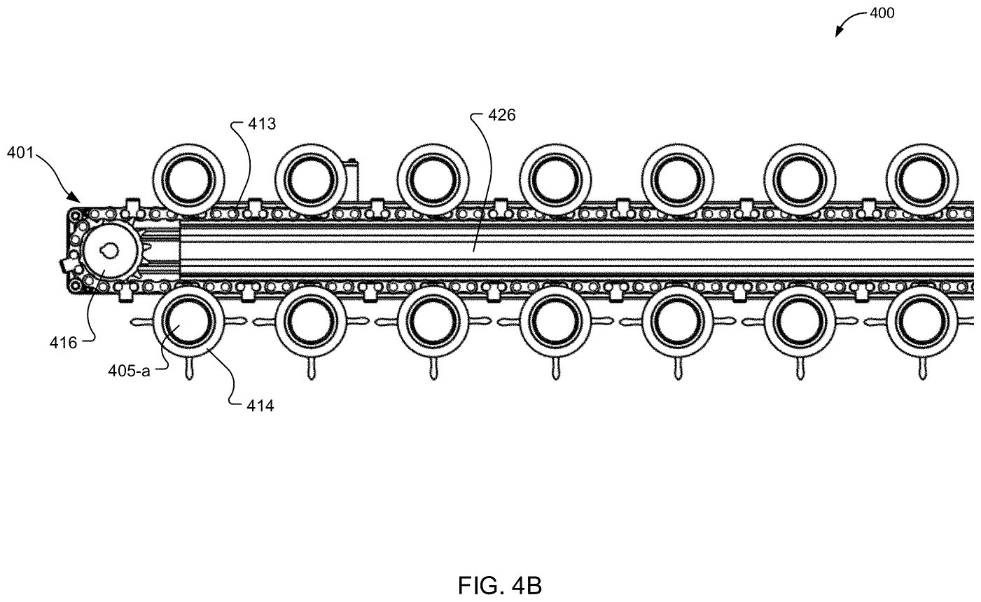

After applying the obscurant layer 125 (i.e., one or more layers of the obscurant coating), can 105-b may rest for a brief period of time (e.g., 3 minutes, 4 minutes, 10 minutes, etc.) prior to curing in a curing oven 125. In some cases, the can 105-b may rest at or near room temperature (e.g., 22 degrees Celsius), although other pre-cure resting temperatures are contemplated in other embodiments. As shown, once in the curing oven 125, the can may now be referred to as can 105-c. Can 105-c may be cured in the curing oven 125 at a pre-configured temperature (e.g., 350 degrees Fahrenheit, 400 degrees Fahrenheit, 390 degrees Fahrenheit, etc.) for an amount of time (e.g., 1 minute, 6 minutes, 10 minutes, 20 minutes, etc.) which may allow the obscurant layer 125 to solidify into a hard, impermeable protective shell, as further described in relation to FIGS. 4A-B and 5A-C

In some cases, following application and curing of the obscurant layer 125, one or more colors of a second ink decoration (i.e., ink layer 115-a) may be applied over the obscurant layer 125 and the first overvarnish layer of the can 105-b, now represented by can 105-d. In some cases, one or more colors of a second ink decoration (e.g., ink layer 115-a) may be embodied in the obscurant layer 125 and be applied over the first overvarnish layer of the can 105-b, now represented by can 105-d. Alternatively, if the obscurant layer 125 was cured in the curing oven (or other energy source) 126, ink layer 115-a may be applied over the overvarnished, surface treated, and cured can 105-c, also represented by can 105-d. In some embodiments, the one or more layers of ink may be applied to the entire curvilinear side surface of the can, including neck and flange portions, as well as the base. In other cases, the one or more layers of ink may be applied to only a portion of the curvilinear side surface, for instance, based on design requirements. In either case, surface treating the entire curvilinear side surface of the can may allow ink to be applied from the base to the top (necked) portion of the can 105-c (or can 105-b, if no curing following application of obscurant layer). Also, applying obscurant layer 125 to the entire curvilinear side surface of the can may allow ink to be applied from the base to the top (necked) portion of the can 105-c such that little to none of the first decoration layer 114-a is visible underneath the second ink layer 115-a. As shown, can 105-d comprises one or more layers of the obscurant coating and one or more layers of the second ink layer 115-a applied on its neck 110-b, as well as its side surface. In some cases, ink layer 115-a may also be applied to a base 130-b of can 105-d.

In some cases, one or more layers of a second overvarnish (i.e., second overvarnish layer 120-b) may be applied to the entire curvilinear side surface of can 105-d, now represented by can 105-e. As shown in FIG. 1, can 105-e illustrates the various layers applied over can 105, including the obscurant layer 125, the second ink layer 115-a, and the second overvarnish layer 120. The various layers shown on can 105-e are for illustration purposes only, and not to be construed as limiting in nature. Further, it should be noted that the decoration layer 114-a comprising the first ink layer and the first overvarnish layer have not been shown, since they are obscured by the obscurant layer 125. In some cases, can 105-e may be coated from its top (necked) portion to its base with obscurant layer 125, which was previously cured (e.g., can 105-c) to form a hard shell with adequate slip characteristics. Further, can 105-d comprising the second decoration (e.g., ink layer 115-a) over the obscurant layer 125 may be coated with one or more layers of the second overvarnish layer 120, now represented as can 105-e. This can 105-e may then be cured in the curing oven 126, now represented as can 105-f. In some examples, can 105-f may be ready for filling and packaging, following which it may be delivered to a customer. It should be noted that, the second overvarnish layer 120 may cover the entirely of the second ink layer 115-a. In other cases, following application of the obscurant layer 125, can 105-c may be coated from its top (necked) portion to its base with second ink layer 115-a, and second overvarnish layer 120 may cover the entirely of the second ink layer 115-a. Further, the second ink layer 115-a may cover only a portion of the obscurant layer 125. In some cases, the second overvarnish layer 120 may include a water-soluble and/or non-UV curable overvarnish. Alternatively, the second overvarnish layer 120 may be a UV curable overvarnish.

In some examples, after applying the second overvarnish layer 120 (i.e., one or more layers of the second overvarnish), can 105-e may rest for a brief period of time (e.g., 3 minutes, 4 minutes, 10 minutes, etc.) prior to curing in the curing oven 126. In some cases, the can 105-e may rest at or near room temperature (e.g., 22 degrees Celsius), although other pre-cure resting temperatures are contemplated in other embodiments. As shown, once in the curing oven 126, the can may now be referred to as can 105-f. Can 105-f may be cured in the curing oven 126 at a pre-configured temperature (e.g., 350 degrees Fahrenheit, 400 degrees Fahrenheit, 390 degrees Fahrenheit, etc.) for an amount of time (e.g., 1 minute, 6 minutes, 10 minutes, 20 minutes, etc.) which may allow the second overvarnish layer 120 to solidify into a hard, impermeable protective shell, as further described in relation to FIGS. 4A-B and 5A-C.

Curing duration and temperature may vary depending on the specific primer material, obscurant coating, overvarnish or adapted overvarnish, as well as the type of curing oven used. For example, in some cases, a curing temperature of 365° F. for one minute may suffice in curing some obscurant coatings. In order to achieve this, the wet can coated with the obscurant layer 125 (i.e., can 105-c) may be placed on pins, where the pins may be used to separate the can 105-d from adjacent cans 105 (not shown) on a rack. After placement, the rack comprising the pins and cans may be placed in a laboratory oven or a curing oven (shown as curing oven 400 and 500 in FIGS. 4A-B and 5A-C, respectively), where the laboratory or curing oven may be set to 400° F. for approximately two minutes. It should be noted that, the oven set temperature and actual time spent by the cans in the oven may differ from the cure temperature and curing time, since can 105-e may take some amount of time to reach the desired cure temperature. Further, the temperature of the oven may drop when opened, which may also need to be accounted for, and may depend on the duration of time the oven was opened while transferring cans into it. Accordingly, the oven set temperature and oven period (i.e., time spent by cans in the oven) may vary depending on the specific obscurant coating and curing oven used. In some other cases, curing times and temperatures may be based on, for instance, an ink formulation (e.g., of ink layer 115-a). In one example, the ink used for printing the second decoration layer or ink layer 115-a on the cans may comprise a solvent component specifically designed to facilitate the curing of both the ink layer 115-a and the second overvarnish layer 120. In some cases, to avoid over curing of the obscurant layer 125, overvarnish layer 120, and/or any applied inks, the surface temperature attained by cans may be limited, for instance at or below 390° F. In some cases, over curing of the overvarnish and/or inks may result in discoloration or adhesion issues, which may adversely affect the quality of the final product. After leaving the curing oven, the cured cans may be cooled and transferred to a medium, such as a shipping pallet via a palletizer or a cardboard carton via an accumulation table, for delivery to the customer.

FIG. 2 relates to an example embodiment of a surface treatment process for preformed necked cans in accordance with one or more implementations. In particular, FIG. 2A illustrates a system level diagram of a blown-ion plasma system 200-a which may be deployed to increase the surface energy of an overvarnish coating (e.g., first overvarnish layer of the decoration layer 114-a in FIG. 1) applied to an unprinted, necked, and flanged can 205-a. In some other cases, can 205-a may be a previously decorated can (e.g., printed can). FIGS. 2B-D illustrate a perspective view, a side view, and a bottom view, respectively, of an embodiment of the blown-ion system 200-a in FIG. 2A, according to aspects of the present disclosure. In some embodiments, the blown-ion plasma system 200-a may also be used to increase the surface energy of a primer coating or an obscurant coating (e.g, obscurant layer 125 in FIG. 1) prior to application of one or more layers of a second decoration (e.g., ink layer 115-a in FIG. 1). In such cases, the can comprising the obscurant coating may or may not have been cured (e.g., in a curing oven) following application of the obscurant layer.

As shown, blown-ion plasma system 200-a comprises a blown ion-plasma treater 201-a and can 205-a. In some embodiments, blown-ion plasma treater 201-a may comprise one or more ion treater heads 202. Each ion treater head 202 may comprise a nozzle 203 and one or more coaxial electrodes (not shown) across which a high-voltage plasma is created. In some examples, high-pressure air 206-a may flow through tube 204 in ion treater head 202 until it interacts with the coaxial electrodes. As shown, an electrical discharge 211 may be applied by the coaxial electrodes to the high-pressure air 206-a to generate a mixture 206-b comprising charged ions (e.g., positively charged ions) in the surrounding air particles. Furthermore, in some cases, the air pressure may force the air particles and stream of charged ions (i.e., mixture 206-b) to accelerate towards the nozzle 203, which may then be blown through the nozzle as blown-ion plasma 212. In some cases, the blown-ion plasma 212 may also be referred to as a blown-ion air plasma or an ion/plasma plume. In some cases, blown-ion plasma 212 may extend a distance from the nozzle 203, such as one to two centimeters, and interact with the nearby surface of the can 205-a. The blown-ion plasma 206-c may positively charge the surface layer of the can 205-a upon contact, which may assist in cleaning, micro-etching, and functionalizing the surface of the can 205-a by increasing its surface energy. In some cases, the blown-ion plasma 206-c may enable the surface energy of the overvarnish coating of the can 205-a to be raised to a minimum of 56 dynes/cm. In some examples, a surface energy of 56 dynes/cm or more may enable applied obscurant coatings (or inks) to adhere to the overvarnish coating of the necked and flanged can 205-a, even when crushed. In other cases, a surface energy of 30-35 dynes/cm may be sufficient to allow obscurant coating or ink adhesion. In some cases, the dyne level may affect the robustness and adhesion of the obscurant layer (e.g., obscurant layer 125 in FIG. 1) to be applied. Further, the minimum dyne level may be based on one or more factors, including the type of obscurant coating or overvarnish used and/or thickness of overvarnish (i.e., first overvarnish layer).

FIG. 2B illustrates a perspective view of a blown-ion plasma system 200-b according to aspects of the present disclosure. In some cases, blown-ion plasma system 200-b may implement one or more aspects of blown-ion plasma system 200-a previously described in relation to FIG. 2A. Further, FIGS. 2C and 2D illustrate a side view and a bottom view, respectively, of the blown-ion plasma system 200-b seen in FIG. 2B.

In some cases, blown-ion plasma system 200-b may comprise one or more cans 205 (e.g., can 205-b), blown ion plasma treaters 201, and a robot assembly 208. As shown, blown ion treaters 201 may comprise ion treater heads 202, where each ion treater head 202 further comprises a nozzle 203. In some embodiments, the robot assembly 208 may comprise one or more rotatable chucks 207 for securely holding and spinning (i.e., axially rotating) the cans 205 at a desired rotational speed. In some embodiments, one end of the can 205 (i.e., either the base or the open mouth of the can) may be placed, either manually or automatically, in a port of a rotatable chuck 207. In some cases, the rotatable chuck 207 may be an example of a vacuum chuck and may comprise an intake for connecting to a vacuum system.

In some cases, each ion treater head 202 may be suspended upon a support arm (not shown) that is configured to translate ion treater heads 202 along an axis extending along the length of the can 205. The support arm may move each ion treater head 202 at variable rates depending on, for example, the region or zone of the can 205 the ion treater head 202 is treating. In some circumstances, some zones of necked and flanged cans may have little contamination, such as a bottom third of the can, and as a result may achieve a desired surface energy more quickly, allowing the ion treater head 202 to move through these zones at a greater speed. On the other hand, some zones of the necked and flanged cans, such as neck 210, may achieve a desired surface energy more slowly due to a greater distance from each ion treater head nozzle 203 or a heavier contamination level. Accordingly, the ion treater head 202 may move more slowly through these zones, as compared to zones that may achieve a desired surface energy more quickly.

In some examples, the zone configuration, speed at which each an ion treater head 202 moves through each zone, and rotational speed of the can 205 to achieve a desired surface energy in the least amount of time may be determined by measuring the resulting surface energy of the can 205 by iteratively testing different potential zone configurations, ion treater head speeds, and can rotation speeds. In some embodiments, the resulting surface energy of the can, such as can 205-b, may be measured using a Dyne Pen, although other surface energy testing devices are contemplated in different embodiments.

In some embodiments, multiple ion treatment heads 202 may be configured to treat the entire curvilinear length of the can 205. Such a technique may serve to reduce processing time by limiting translational movement of the can and/or treatment head. In some embodiments, additional ion treatment heads 202 may be applied to a given region of the can 205 to apply a greater level of treatment in that region (i.e., without any or minimum translational movement). In some other cases, an ion treater head comprising multiple coaxial electrodes and/or multiple nozzles may be used as an effective low-cost alternative to adding additional ion treater heads. For instance, in some cases, ion treater heads may comprise multiple nozzles, where each nozzle comprises one or more coaxial electrodes. In other cases, multiple sets of coaxial electrodes may be built into a single ion treater head comprising a single nozzle. In either way, a single ion treater head could be used to surface treat a can, instead of needing multiple ion treater heads. In some further embodiments, the blown ion plasma treatment process may be integrated with an ink printer (not shown), such as a digital inkjet printer, to optimize production efficiency.

Turning now to FIG. 2D, which illustrates a bottom view of the blown-ion plasma system 200-b. In some cases, robot assembly 208 may be coupled to a pulley system 214, where the pulley system 214 comprises one or more wheels 213, also referred to as pulleys, and a cable 209. The cable 209 may be installed or wrapped around the one or more rotatable chucks (e.g., rotatable chucks 207 shown in FIG. 2B) holding the cans. In this way, the rotatable chucks and pulley system 214 may enable the cans 205 (e.g., can 205-b) to be held and spun in place in front of the nozzles 203 of the blown-ion treaters 201. In another implementation, the pulley system 214 may be replaced by a series of individually driven rotary motors, each of which is attached to the one or more rotatable chucks. In yet another implementation, the rotary motors may be replaced with linear rotary actuators attached to the one or more rotatable chucks, allowing them to move in a linear motion as they rotate. In this case, a separate robot assembly, similar to robot assembly 208, may be used to translate the nozzles 203 in a direction adjacent to the surface of the cans. In some embodiments, the robot assembly 208 may comprise a controller, where the controller comprises processor-executable code encoded in a non-transitory tangible processor readable storage medium. In some cases, the code, when executed by the controller, may be configured to cause the controller to vary a rotational speed of the vacuum chucks, for instance, by changing the speed and/or tension in the cable 209 of the pulley system 214.

FIG. 3 illustrates an example of a surface treatment process for preformed necked cans in accordance with one or more implementations. For instance, FIG. 3 illustrates a system level diagram of a laser surface treatment system 300 and may implement one or more aspects of the figures described herein, including at least FIG. 1. In some cases, laser surface treatment system 300 may be used to modify the surface topography and/or chemistry of a can 305 as a means of increasing a surface energy of can 305 and making it more receptive to an obscurant (or ink) layer. Specifically, in some examples, laser surface treatment may be deployed to increase the surface energy of an overvarnish coating (e.g., first overvarnish layer of decoration layer 114-a in FIG. 1) applied to can 305. In some examples, can 305 may be a preformed necked can, that may or may not be previously overvarnished (i.e., comprise a first overvarnish layer). In some cases, preformed necked can 305 may be unprinted. In some other cases, the preformed necked can 305 may be an example of a previously printed, necked, flanged, and overvarnished can.

In some cases, laser surface treatment system 300 may comprise a laser 303 capable of generating a focused laser beam 304. In some cases, the focused laser beam 304 may be directed onto the surface (e.g., curvilinear side surface) of can 305. Optical energy from the laser radiation absorbed by the can surface may induce heating, which in some cases, may be sufficient to melt or even vaporize the surface material of the can 305. In some cases, the radiation from the laser beam 304 may facilitate in removing some or all of the surface material, debris, contamination, etc., from the can 305, thus modifying the surface topography of can 305. In other words, the laser radiation may modify the roughness of the curvilinear side surface of can 305. In some cases, laser radiation or any other type of electromagnetic radiation, such as UV radiation, with sufficiently energetic photons may be capable of breaking chemical bonds and/or changing the surface chemistry of a material. In some other cases, the radiation from the laser beam 304 may facilitate in removing all or nearly all of the ink forming the first decoration and/or all of the first overvarnish from the can 305. In some aspects, the laser surface treatment system 300 may eliminate the need for an obscurant layer and facilitate enhanced wet-out of a new ink layer and/or a new overvarnish layer by modifying the surface topography of the can 305.

In some embodiments, one or more of thermal and chemical laser-induced processes may be used, simultaneously, to modify surface characteristics of can 305. Furthermore, as shown, the focused laser beam (e.g., laser beam 304) may be manipulated to rapidly scan the surface of can 305, thus modifying its surface in such a way so as to increase its surface energy and make it more suitable for printing. For instance, the laser beam 304 may be configured to be rotated or spin using a controller. Additionally or alternatively, the can 305 may be spun or rotated, for instance, using a rotatable chuck or another applicable system. By controlling the direction and speed with which the laser beam 304 is scanned, the transmitted energy and effective shape of the laser beam may be modified in one or more applicable ways to optimize treatment of a can's surface, such as the surface of a can spinning on a rotating chuck (e.g., rotatable chuck 207 seen in FIG. 2D).

In some embodiments, a scanning laser beam system, such as laser surface treatment system 300, may be used to emulate, and enhance the action and performance of a plasma treater system, such as blown-ion plasma system 200-a or 200-b shown in FIGS. 2A and B, respectively, or another surface treatment system (e.g., corona treatment system, flame treatment system, etc.). In some cases, laser beam 304 may be scanned in a direction that is either parallel or perpendicular to the spinning can's access, or in a pattern combining both parallel and perpendicular movements. In one particular embodiment, the scanning head of laser 303 may be held a fixed distance (e.g., 5 mm, 10 mm, 2 inches, etc.) from the surface of can 305, or alternatively from the long axis of the spinning can 305, and moved along a line that is parallel to the long axis as the can spins. In any case, the intended effect of laser surface treatment system 300 is to allow the various portions of the surface of can 305 to be treated as much or as little as required, for instance, to achieve a uniform surface energy over the entire surface of the can 305, which may facilitate application of an obscurant layer.

FIGS. 4A and 4B illustrate an example of a curing oven 400 for curing preformed necked cans in accordance with one or more implementations. Curing oven 400 implements one or more aspects of FIG. 1 and other figures described herein. Furthermore, FIG. 4B incorporates one or more aspects of FIG. 4A, and other figures described herein.

In some cases, after surface treating, applying an obscurant layer, painting, and applying a second layer of overvarnish on a can 405-a, the can 405-a may optionally undergo a pre-cure rest for a brief period of time, such as four minutes, at or near room temperature (e.g., 22 degrees Celsius, 24 degrees Celsius). It should be noted that the curing oven 400 may also be utilized after applying a primer layer or an obscurant layer on a can 405, such as can 405-a, and before applying the second decoration layer and second overvarnish layer. In some cases, the can 405-a may be an example of a wet and overvarnished can (e.g., can with obscurant coating or can with obscurant coating, paint, and second overvarnish layer). In some embodiments, the can 405-a may undergo the pre-cure rest in a clean environment, such as on a conveyor belt en route to the curing oven 400. In some aspects, this pre-cure rest may enable the adapted overvarnish to settle, as well as allow entrapped air bubbles to escape, which may serve to reduce visual and tactile defects in the adapted overvarnish surface coating.

As shown in FIG. 4A, which depicts a perspective view of the curing oven 400, one or more wet cans 405 (e.g., can 405-a) that may or may not have undergone a pre-cure rest may be transferred into the curing oven 400 to cure the coatings (e.g., one or more second overvarnish layers) applied to each can. The curing oven 400 may be any oven that allows for the uniform heating of the cans 405 at a pre-defined temperature (e.g., 300, 350, 375 degrees Fahrenheit) for an amount of time required to cure the coating of each can 405. In some cases, the curing process may serve to remove volatiles from the obscurant coating layer(s) and/or adapted overvarnish and solidify them into a hard, impermeable protective shell.

As seen in FIGS. 4A (perspective view) and 4B (bottom view), the base of each can 405 may be held in a rotatable seat 414 attached to a conveyance mechanism 401. The conveyance mechanism may comprise a gear system 416 including a chain 413, although other conveyance systems are contemplated in different embodiments. Further, rotatable seats 414 holding cans 405 may be conveyed through the curing oven 400 by rotation of the chain 413 and the gear system 416.

In some embodiments, the circumference of the rotatable seat 414 may be in continuous contact with a fixed rail 426 or other surface, and the rotatable seat holding the can may be continuously rotated as the can 405 is conveyed through the oven 400 via the chain 413 and gear system 416. In some other cases, the base of each can 405 may be held in a rotatable seat 414 attached to the conveyance mechanism 401, such that the base of the rotatable seat 414 comprises a rod 430 that has a geared cog 429 at one end. In some examples, the geared cog 429 may make intermittent contact with protrusions (not shown) incorporated into the fixed rail 426 or other surface, and thereby rotate by a fixed angle each time the geared cog 429 makes contact with one of the fixed protrusions as the can 405, such as can 405-a, is conveyed through the oven 400. In another particular embodiment, a geared cog, similar to the geared cog 429, may be located along the circumference of a rotatable seat 414 (not shown). Similar to the geared cog attached to the end of rod 430, a geared cog located along the circumference of a rotatable seat may make intermittent contact with protrusions (not shown) incorporated into the fixed rail 426 or other surface, and thereby rotate by a fixed angle each time it makes contact with one of the fixed protrusions as the can 405 is conveyed through the oven 400. In another embodiment, the rotatable seats may each be attached to individual rotary actuators that continuously or intermittently rotate the rotatable seats and cans as they move through a curing oven via a conveyor belt, rotating wheel, or some other means of linear or rotational conveyance.

In some embodiments, the curing oven 400 may consist of one or more infrared heat sources (not shown), for example, electric infrared heat panels, arrayed so that the entirety of the coated surface of each can 405 transferred into the oven 400 attains the desired cure temperature for the desired period of time.

Returning to FIG. 4A, in some cases, the curing oven 400 may comprise a controller 417 adapted to maintain the internal temperature of the curing oven 400 to the pre-defined temperature set for curing cans 405. In some embodiments, the controller 417 may also be configured to control the speed of conveyance mechanism 401 (e.g., gear system 416 and chain 413), which may in turn control the speed of the cans 405 being conveyed through the curing oven 400.

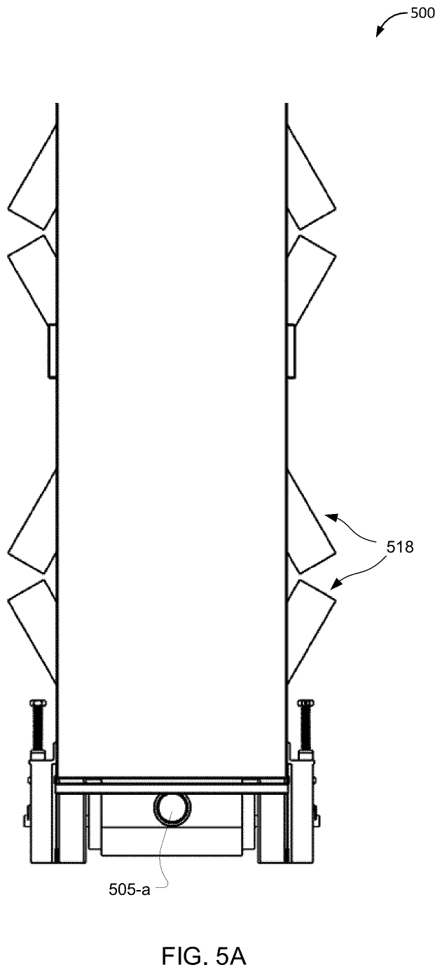

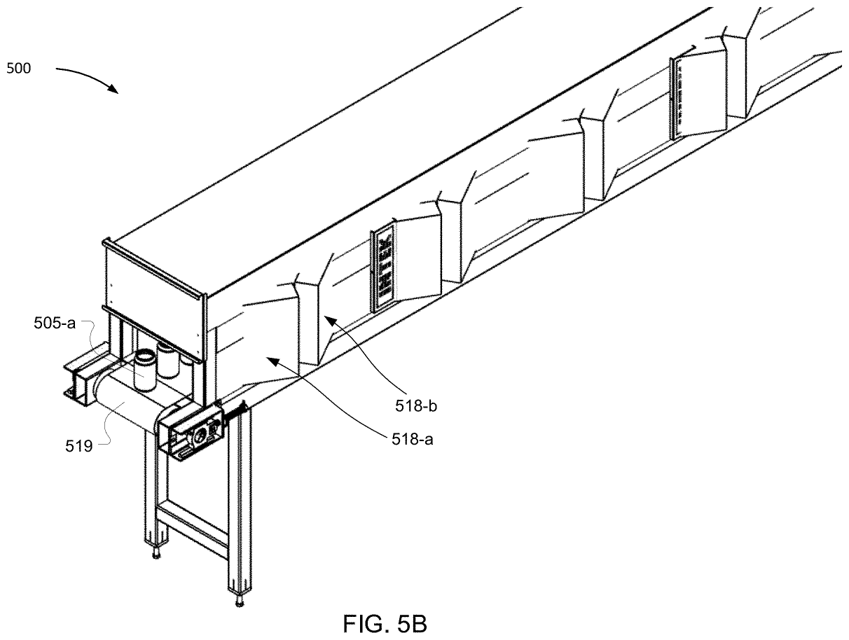

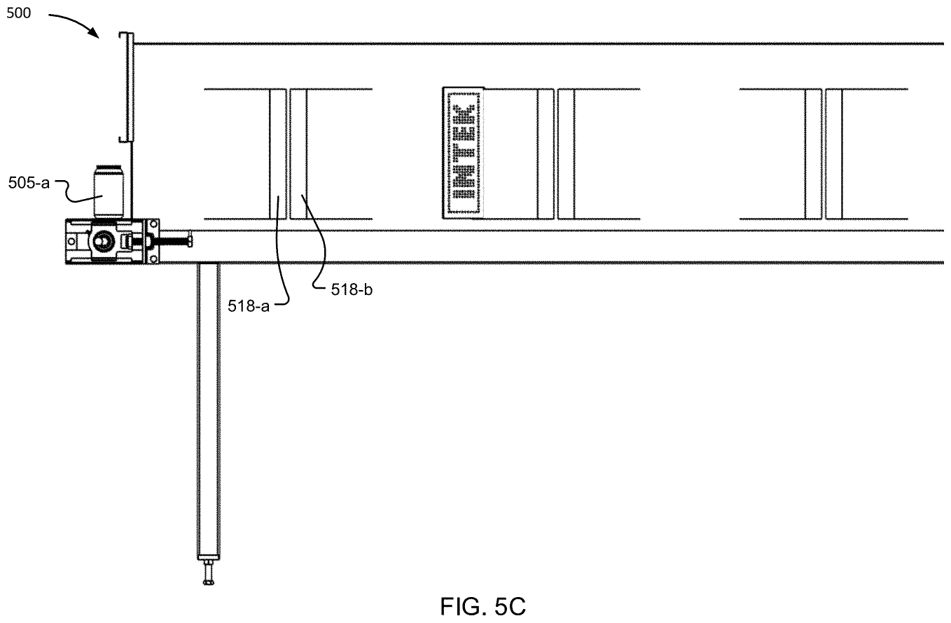

FIGS. 5A, 5B, and 5C illustrate an alternate embodiment of a curing oven 500 for curing preformed necked cans in accordance with one or more implementations. FIGS. 5A, 5B, and 5C illustrate a top view, a perspective view, and a side view, respectively, of the curing oven 500. For ease of presentation, it should be noted that, only an interior portion of the curing oven focusing on its inner workings are seen in FIGS. 5A, 5B, and 5C. That is, while the figures depict one or more sides of the curing oven 500 as being open (e.g., towards the top in FIG. 5A, and towards the right and left in FIGS. 5B and 5C), it should be noted that, during implementation, the curing oven 500 may be sealed on both sides. In fact, sealing the curing oven on both sides may serve to ensure uniform heat distribution within its inner cavity.

In some cases, after surface treating, applying an obscurant layer, painting, and applying a second layer of overvarnish on a can 505-a, the can 505-a may optionally undergo a pre-cure rest for a brief period of time, such as four minutes, at or near room temperature (e.g., 22 degrees Celsius, 24 degrees Celsius). In some examples, FIGS. 5A-C may implement one or more aspects of FIGS. 4A and 4B, and other figures described herein. Furthermore, it should be noted that the curing oven 500 may also be utilized after applying an obscurant layer on a can 505, such as can 505-a, and before applying the second decoration layer (e.g., second ink layer 115-a in FIG. 1) and second overvarnish layer (e.g., overvarnish layer 120 in FIG. 1).

It should be noted that the can 505-a may be an example of a wet and overvarnished can, for instance, due to the layers of primer material, obscurant coating, ink and/or overvarnish that have not yet been cured. In some embodiments, the can 505-a may undergo the pre-cure rest in a clean environment, such as on a conveyor belt en route to the curing oven 500. As previously described, a pre-cure rest period following obscurant coating or overvarnishing may enable the adapted overvarnish to settle, as well as allow entrapped air bubbles to escape, which may serve to reduce visual and tactile defects in the obscurant or adapted overvarnish surface coating.

In some embodiments, the curing oven 500 may contain a conveyance mechanism (shown as conveyance mechanism 519 in FIG. 5B) that transports the cans 505 through the oven 500 and in proximity to one or more infrared heat sources 518 (e.g., infrared heat source 518-a, infrared heat source 518-b), such that the coatings are cured during the oven transit time. In some embodiments, the conveyance mechanism 519 may have a means to re-orient cans 505, such as can 505-a, for example, by continuously or periodically rotating the can 505-a as it passes through the oven 500, which may allow all coated can surfaces to attain the desired curing temperature and dwell time in an optimized amount of time.

In other embodiments, multiple infrared heat sources 518 may be oriented at different angles or locations relative to the can path, which may allow heat radiated from the heat sources 518 to impinge, directly, on a larger total can surface area than might occur if all the heat sources are oriented in a same direction relative to the can path. As illustrated in FIGS. 5A-C, infrared heat sources 518 may be arrayed in a zig-zag pattern on one or more sides of the can path such that the primary direction of the heat radiated from a given heat source (e.g., heat source 518-a) is angularly offset, for example, by thirty or ninety degrees, relative to the primary direction of the heat radiated from an adjacent heat source (e.g., heat source 518-b). In some aspects, such an arrangement of heat sources may serve to augment the total irradiated surface area of the cans 505 at any given time (i.e., as compared to the surface area that may be irradiated when all of the heat sources are similarly aligned).

In some embodiments, the curing oven 500 may be a forced convection oven that continuously moves air over the surface of the cans 505 for efficient heat transfer, which may allow for uniform temperatures amongst the cans 505. In some embodiments, the curing oven 500 may be a forced convection continuous conveyor oven with a perforated fiberglass conveyor mat (e.g., installed over or as part of the conveyance mechanism 519), which may allow hot air to flow through the mat and cure the cans without needing to displace the cans 505.

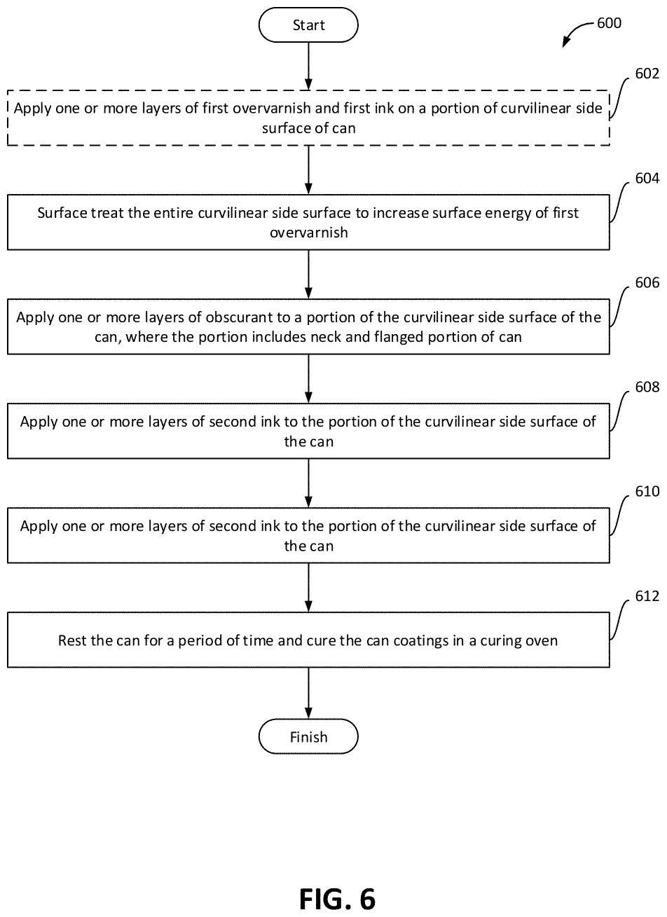

FIG. 6 illustrates a flowchart of one embodiment of a method 600 for surface treating and applying an obscurant coating to previously decorated preformed necked cans. In some examples, the method 600 relates to treating and redecorating a previously decorated necked and flanged can by obscuring the original decoration, applying a second decoration to a portion or the entire curvilinear profile of the necked and flanged can, either as the obscurant layer itself or in conjunction with a dedicated obscuring layer, and applying a second overvarnish layer to at least the portion (or alternatively, the entire curvilinear profile) of the can. It should be noted that other types of previously printed and/or overvarnished cans not described herein are contemplated in some embodiments. In some cases, a can containing a curvilinear profile may imply that the can contains both curved (e.g., neck) and linear (e.g., side surface of can) segments. Method 600 may implement one or more aspects of FIG. 1 and other figures described herein.

In some cases, at block 602, one or more layers of a first ink decoration and a first overvarnish, collectively referred to as the first decoration layer, may be applied on the curvilinear side surface of a can, such as can 105 in FIG. 1. It should be noted that the dotted lines around block 602 may imply an optional step. For instance, a beverage/food producer, or a can decorator may receive cans from a can manufacturer, where the cans have been treated (e.g., first ink decoration, first overvarnish application and curing), following by necking and flanging. In this case, block 602 may be deemed to be optional, since one or more layers of first overvarnish have already been applied on the side surface of the can.

In some cases, at block 604, the entire curvilinear side surface of the necked and flanged can (e.g., previously decorated with a first decoration layer) may be treated to increase the surface energy of its overvarnish coating as well as any lubricant that may have contaminated the neck of the can, which may assist the can surface in “wetting out” inks for an enhanced appearance and/or for optimized obscurant (or ink) adhesion. For example, a surface energy of 30-35 dynes/cm or more may enable applied obscurant layers (or inks) to adhere to the overvarnish coating of the necked and flanged can, even when crushed. In some other cases, a higher minimum surface energy, such as 56 dynes/cm, may be needed to enable obscurants (or inks) to adhere to the first overvarnish layers.

As previously described in relation to FIGS. 1 and 2A-D, in some embodiments, the surface treatment may include a blown ion plasma treatment, which may be applied by a blown ion plasma treatment machine consisting of one or more ion treater heads. Each ion treater head may have a nozzle consisting of coaxial electrodes across which a high-voltage plasma is created. High-pressure air may be blown through the nozzle to cause an ion or plasma plume to extend a distance from the nozzle, such as one to two centimeters, and interact with the nearby surface of the can. The ion plume may positively charge the surface layer of the can upon contact, which cleans, micro-etches, and functionalizes the surface of the can by increasing its surface energy.

In an example embodiment, one end of the can, either the base or the open mouth of the can, may be placed, either manually or automatically, on a rotatable chuck (e.g., a vacuum chuck). The rotatable chuck may be configured to securely hold and spin the can at a desired rotational speed. In some cases, each ion treater head may be suspended upon a support arm configured to translate each ion treater head along an axis extending along the length of the can (e.g., longitudinal axis). In some cases, the support arm may move each ion treater head at variable rates depending on, for example, the region or zone of the can the ion treater head is treating. Some zones of necked and flanged cans may be less contaminated as compared to other zones. For instance, the bottom third of the can may be an example of a zone that experiences less contamination. Further, the top portion of the can, such as the neck and flanged portion, may experience a higher level of contamination due to the previous application of necking lubricant and/or the first overvarnish coating. As a result, the bottom third of a can may, for instance, achieve a desired surface energy more quickly, allowing ion treater heads to move through this zone at a greater speed. On the other hand, the neck may achieve a desired surface energy more slowly, based on one or more factors, including a greater distance from each ion treater head nozzle, or a heavier contamination level. In such cases, the ion treater head may move through the zone comprising the neck more slowly.

As noted above, the zone configuration, speed at which each ion treater head moves through each zone, and rotational speed of the can to achieve a desired surface energy (i.e., in an optimum amount of time) may be determined by iteratively testing different potential zone configurations, ion treater head speeds, and can rotation speeds, and measuring the resulting surface energy of the can with, for example, a Dyne Pen. In some embodiments, and as previously described in relation to FIGS. 2A-D, multiple ion treatment heads may be utilized to treat the entire curvilinear length of the can. In some cases, the use of multiple ion treatment heads may serve to reduce processing time, since the ion treatment heads may not require any translational movement to surface treat the entire portion of the can(s). Additionally or alternatively, multiple ion treatment heads may be utilized to treat a given region of a can, which may also minimize the need for any translational movement. As noted above, in some other cases, multiple coaxial electrode sets may be integrated into a single ion treatment head, which may alleviate the need for multiple ion treatment heads. In such cases, the single ion treatment head may comprise one or more nozzles, where each nozzle may be associated with one or more coaxial electrodes.

In some embodiments, the blown ion plasma treatment process may be integrated with a printer or other obscurant applicator, such as a digital inkjet printer, to increase production efficiency. In some embodiments, the necked and flanged can treatment may also include laser surface treatment, detergent washing, corona treatment, chemical etching, chemical plasma treatment, flame treatment, and/or application of primer materials, to name a few non-limiting examples.

In other embodiments, block 604 may comprise the use of a laser surface treatment for modifying the can's surface topography and/or chemistry. As previously described, laser surface treatment may also be used to remove all or a majority of the first overvarnish layer and the ink forming the first decoration layer (e.g., if the can was previously printed or decorated). Laser surface treatment may be utilized as a means of increasing the surface energy of the can and/or the first overvarnish coating on the can, thus making it more receptive to an obscurant layer applied at block 606. In some cases, laser surface treatment may comprise radiating or directing a focused laser beam onto the can surface. Optical energy from the absorbed laser radiation may induce heating sufficient to melt or vaporize the surface material and/or the sub-surface material, thus removing some or all of it, in addition to modifying the surface topography (i.e., modifying its roughness). In some examples, an ultra-violet (UV) or other laser with sufficiently energetic photons may break chemical bonds within the surface material (i.e., can surface) and change its surface chemistry. In many cases, both the thermal and chemical laser-induced processes may simultaneously modify surface characteristics of the can. Much like the plasma-based surface treater described above (also in relation to FIGS. 2A-D), a focused laser beam of a minimum threshold energy may be manipulated to rapidly scan the surface of a can. Directing a focused laser beam (e.g., described in relation to FIG. 3) onto a can surface may serve to modify its surface, and cause its surface energy to increase, which may facilitate in making the can surface more suitable for applying the primer or obscurant. By controlling the direction and speed with which the laser beam is scanned, the transmitted energy and effective shape of the laser beam may also be modified in one or more ways. In some aspects, the use of dynamic and adaptive laser beams for surface treating cans, as described in this disclosure, may optimize the surface treatment of can surfaces, such as those spinning on a rotating chuck. In some cases, the rotating chuck used for laser surface treatment may be similar or substantially similar to the rotating chuck used for blown ion surface treatment. In some examples, the rotating chuck may be a vacuum chuck, although other types of chucks are contemplated in different embodiments. In one example, laser beams may be scanned in a parallel or perpendicular direction to the spinning can's access, or in a pattern combining both parallel and perpendicular movements. In one particular embodiment, the scanning head of the laser may be held a fixed distance from the can surface, for example, five or ten centimeters, or alternatively from the long axis of the spinning can. Further, the scanning laser head may be moved along a line that is parallel to the long axis of the can as the can spins.

In some embodiments, a scanning laser beam system may be used in conjunction with or in addition to a blown-ion plasma treatment system. In other words, the scanning laser beam surface treatment system may serve to emulate, and enhance, the action and performance of a plasma treater system. In other cases, only one of scanning laser beams or blown-ion plasmas may be used to surface treat cans, for instance, based on the use case. In any case, the intended effect of surface treating devices (e.g., laser surface treatment, blown-ion plasma, corona treatment, flame treatment, etc.) is to allow the various portions of a can surface to be treated as much or as little as required in order to achieve a uniform surface energy over the entire surface of the can, including the neck and flange portions.

After surface treating the entire curvilinear side surface of the can, the treated necked and flanged can may be transferred to a printer, sprayer, or other obscurant application device, such as a spray machine. In some cases, the sprayer may be capable of applying the obscurant to the entire curvilinear side of the can, including the straight walls of the cans, the curved walls at the bottom of the cans, and the necks of the cans. In one example, the sprayer may apply one or more layers of obscurant over at least a portion of the curvilinear side surface of the can, or even the entire curvilinear side surface (e.g., from a point on the bottom curve of the can base up to or through the neck and flange of the can, or over a subsection of the entire curvilinear side surface of each can). In further embodiments, a sprayer that has been adapted with can handling and conveyance capabilities may also be configured to interact with different sub-systems both upstream (e.g., surface treatment system) and downstream (e.g., second decoration or ink printing system, overvarnish spraying system, curing oven, etc.) from it. In some cases, sprayers may incorporate artificial intelligence or machine learning techniques for optimizing can handling, spraying, etc. In some embodiments, various primers may be applied under the obscurant layer by the sprayer. That is, following surface treating of the previously decorated can, one or more layers of primers may be applied prior to applying the obscurant layer(s). Such primers may also be cured, thermally or otherwise, in a separate process prior to applying the obscurant layer(s). In some other cases, ink primers may be applied as an alternative to surface treating a previously decorated can. Further, it should be noted that the can may be surface treated again following application of the obscurant layer, and before application of the second decoration (or ink) layer.

At block 608, one or more layers of a second ink may be applied to the curvilinear side surface of the can from block 606, where the can from block 606 comprises one or more continuous layers of the obscurant. The region or portion of the can surface to which the second ink may be applied may be the same as or different from the portion to which the first ink was originally applied. As previously described, after applying the obscurant at block 606, the can may be cured in a curing oven prior to applying the second ink.

At block 610, one or more layers of a second overvarnish, such as a water-based polyester or acrylic resin overvarnish may be applied to all or at least the portion of the curvilinear side surface of the can comprising the first ink, the obscurant, and/or the second ink. In this way, the second overvarnish layers may comprise the outermost layers of the side surface of the can. It should be noted that, the overvarnish utilized may be compatible for use with beverage cans produced using traditional processes, including printed cans. In some examples, the applied overvarnish (i.e., one or more layers of the second overvarnish) may cover, for example, any obscurant coating layers, UV-cured inks or coatings, as well as any underlying coatings previously applied by the can maker or decorator. In some cases, such overvarnish layers may be smooth to the touch, or may be applied in such a way so as to create a textured finish which may be appealing to some brand owners and/or consumers. At block 610, the second overvarnish may be applied, for example, by a spraying machine, to at least a portion (e.g., 50%, 70%, 100%) of the curvilinear side surface of the printed can. In some cases, the portion may include the neck and/or flanged portion of the printed can.

In some cases, obscurant coatings and overvarnishes intended to be applied via an offset roller process may be adapted for spraying by adjusting the obscurant or second overvarnish viscosity. In some cases, the desired viscosity may be achieved via dilution of the obscurant or second overvarnish with water. Additionally or alternatively, viscosities may be controlled via temperature adjustment. In either case, adjustment of obscurant or overvarnish viscosity may serve to optimize the spray process by delivering an obscurant or overvarnish coverage that, when cured, may be sufficient to protect the underlying layers from damage, provide a surface with an adequate (or low) coefficient of friction to allow finished cans to be processed efficiently through the can filling and/or can handling equipment, and to minimize migration of ink constituents across the second overvarnish barrier. Additionally or alternatively, adjustment of obscurant viscosity may also allow the obscurant coating to adequately obscure (or cover up) the first decoration layer, such that it is all (or mostly) unperceivable under the second decoration layer.

In one example, distilled or deionized water may be added to an obscurant or overvarnish, such as the second overvarnish. This water-obscurant or water-overvarnish mixture may then be heated within a desired temperature range, such as between 95-105° F., and stirred until a desired viscosity is achieved, such as a 20.0-21.5 second efflux time as measured with a #2 Zahn cup. After achieving the desired viscosity, this adapted overvarnish mixture may then be stored in a reservoir, such as a heated reservoir, maintained within a desired temperature range, such as between 95-105° F., from where it may be pumped into a spray system. It should be noted that the viscosity and temperature ranges discussed above are merely examples and for discussion purposes only. They are not intended to be limiting and should not be construed as such. Different temperature ranges and obscurant or overvarnish viscosities may be contemplated in different embodiments. Additionally or alternatively, different solvents in place of or in addition to distilled or deionized water may be contemplated in other embodiments. In such cases, an obscurant-solvent or overvarnish-solvent mixture may be produced. The obscurant-solvent or overvarnish-solvent mixture may or may not be heated (i.e., only stirred) to produce an adapted obscurant or adapted overvarnish mixture. Further, any of the mixtures described herein may be stored in a temperature controlled (e.g., heated) reservoir, although non-heated reservoirs may be deployed in some embodiments.

In some examples, a pump, such as a hydraulic pump, may be used to pressurize and circulate the adapted obscurant or adapted overvarnish through a series of pressure regulators in the spray system, where the pressure regulators may be used to supply the adapted mixture (e.g., adapted overvarnish and/or adapted obscurant) to one or more spray nozzles at a desired pressure, such as 750-850 psig. In some cases, other overvarnish formulations may optionally be used which may require their own specific dilution, spray temperature, spray pressure and spray time to achieve sufficient overvarnish coverage. In an alternate and optional embodiment, excess obscurant or overvarnish not used by the one or more spray heads may be returned to the heated reservoir via the spray system, which may serve to minimize wastage. It should be noted, however, that any obscurant or overvarnish that has experienced an altered composition (e.g., due to contaminants) may be withheld from returning to the heated reservoir.

In some cases, applying one or more layers of the obscurant or the second overvarnish to the portion of the curvilinear side surface of the can may first comprise transferring the printed can onto a rotatable chuck, such as a vacuum chuck, previously described in relation to FIGS. 1-5. In some cases, the vacuum chuck may be configured to securely hold and spin the can at a desired rotational speed while the spraying machine applies the obscurant or adapted overvarnish to all or a portion of the curvilinear side surface of the can with a programable spray time. In some cases, the programmable spray time may be controlled via a controller. It should be noted that, the obscurant or the second overvarnish may or may not be adapted (e.g., diluted using deionized water or another solvent) prior to application or spraying on the can. In other words, in some cases, the obscurant or second overvarnish may be applied directly from a container or bucket holding the liquid, without dilution.

In a particular embodiment, the can may be secured on the rotatable chuck in a manner such that the open end of the can may be shielded from overspray that may inadvertently enter and potentially contaminate the inside of the can. In another embodiment, the can may be secured on the rotatable chuck in a manner such that the base of the can may be shielded from overspray that may inadvertently cause unwanted obscurant material to be applied to a portion of the base. In a particular embodiment, the base and/or the mouth of the can may be located inside or in the vicinity of a slot or opening through which air is forced, facilitating the removal of any unwanted obscurant material before it comes to rest on the can. In a further particular embodiment, one or more shielding elements may be placed in the vicinity of the can base and/or mouth so as to both block direct application of unwanted obscurant materials and to help direct airflow intended to remove unwanted obscurant materials from the base and/or mouth of the can. In an alternate embodiment, the open mouth of the can may be secured on the rotatable chuck and thereby sealed against the entry of overspray. The programable spray time may be set to minimize or optimize spray overlap, as well as variation in coating thickness. In some cases, the programmable spray time may depend on the rotational speed of the can and/or configuration of each spray head. Additionally or alternatively, the programmable spray time may be set to determine the number of layers of obscurant or overvarnish to apply. In one example, two or three layers of the obscurant or second overvarnish may provide for a surface coating of adequate quality with minimal time spent spraying. In other cases, more or less layers (e.g., single layer) of the obscurant or second overvarnish may be needed. In other cases, one or more layers of the obscurant or second overvarnish may be applied, followed by a cure period, followed by application of another one or more layers of obscurant or second overvarnish, and repeated as often as required to achieve desired coating characteristics.

In some examples, the one or more spray heads used for applying the obscurant or second overvarnish may each comprise one or more airless spray guns containing adjustable nozzle configurations. In such cases, the spray pattern used to apply the obscurant or overvarnish to the can may be controlled based on different application. In some circumstances, the user of the spray system may achieve a variety of desired coatings by adjusting one or more parameters of the spray system, including but not limited to, the number of spray guns, nozzle types, nozzle orientations, nozzle filters, nozzle restrictors (optional), programmable spray times, rotational speed, spray pressures, distance between nozzle tips and can surface, adapted overvarnish temperature, ambient temperature, can orientation, can temperature, obscurant or second overvarnish viscosity, humidity, velocity and temperature of a forced-air cure accelerant. In some cases, the spray system may also comprise one or more sensors, such as temperature, pressure, and/or viscosity sensors.

In one example, an obscurant, overvarnish or adapted overvarnish temperature may need to be adjusted based on a change in an ambient temperature (e.g., temperature of room where a can is being sprayed). Proper setting and curing of an obscurant, overvarnish or adapted overvarnish may require forced air, applied heat, UV energy or other cure accelerants. Such accelerants may be applied either continuously or intermittently during the spray process or between sprayer activations, and appropriate equipment may be integrated into the spray device accordingly. Additionally or alternatively, one or more other parameters besides the obscurant or overvarnish temperature may need to be adjusted to fine-tune the spray system for optimum performance due to a change in the ambient temperature, can temperature, humidity, etc. Accordingly, the controller for the spray system may be used to control one or more of the rotation speed of the can, duration of spray time, motor ramp down after applying the obscurant or overvarnish coating, obscurant or overvarnish viscosity, temperature and velocity of forced heated air or other cure accelerants, etc. In some cases, the spraying system may also allow the user to manually set spray pressures, number of nozzles or ion treater heads, as well as their locations. In some cases, the obscurant or overvarnish temperature may be controlled via a thermostat coupled to a heating element, where the heating element may be located in the reservoir and/or a spray pump.

Similar to the blown-ion surface treatment system described in block 604 and/or FIGS. 1 and 2A-D, the spray system may be integrated with an ink printer, such as a digital inkjet printer, to potentially reduce the time and cost of processing. In another embodiment, the obscurant may be applied directly by a digital inkjet printer using an obscurant/decoration formulation suitable for inkjet spraying. In another embodiment, the obscurant layer may be applied to the entire curvilinear side surface of the printed can, including the neck, by, for example, a roller transfer mechanism. In one example, the roller transfer mechanism may utilize a profiled roller, where the profiled roller may be cut to match the profile of the formed can surface. Additionally or alternatively, the roller transfer mechanism may employ a roller including conformable material, which may assist in adapting the roller surface to the side of the can. In yet other cases, a roller system using multiple rollers, each dedicated to one of the quasi-linear segments of the formed can's profile may be utilized for applying the second overvarnish. Additionally or alternatively, the can may be dipped or submerged into the obscurant in order to apply the obscurant coating.

At block 612, the wet cans coated with one or more obscurant layers, second ink, or overvarnish from blocks 606-610 may undergo a pre-cure rest in a clean environment, such as on a conveyor belt en route to a curing oven, for a brief period of time (e.g., 4 minutes, 5 minutes, 10 minutes, etc.), at or near room temperature. In some cases, the pre-cure rest may be longer or shorter, and the temperature higher or lower than the examples provided above, based on the application on hand. In some aspects, this pre-cure rest may enable the obscurant or overvarnish to settle and/or allow entrapped air bubbles to escape, which may serve to reduce visual and tactile defects in the obscurant or overvarnish surface coating.

Further, in block 612, the wet can or the partially-cured wet can (i.e., if the can has undergone a pre-cure rest) may be transferred into a curing oven to cure the coatings applied to each can, as previously described in relation to FIGS. 1, 4A-B, and 5A-C. In some examples, the curing oven may be any oven that allows for the uniform heating of the can at a pre-configured temperature, and for an amount of time needed to cure the coating of the can. In some circumstances, the curing process may remove volatiles from the obscurant or adapted overvarnish and solidify it into a hard, impermeable protective shell.

In some embodiments, the curing oven may consist of one or more infrared heat sources, for example, electric infrared heat panels, arranged in an array such that the entirety of the coated surface of the can may attain the desired cure temperature. In some cases, the can may be cured in the curing oven for an adequate period of time to allow the coating (e.g., obscurant, second overvarnish, etc.) to cure and solidify. In some embodiments, the curing oven may contain a conveyance mechanism that transports the cans through the oven and in proximity to the one or more infrared heat sources, to allow the coatings to cure during the oven transit time. In some embodiments, the conveyance mechanism may be configured to re-orient the can, for example, by continuously or periodically rotating the can as it passes through the oven, such that all coated zones (e.g., bottom third, neck, flange, top half, etc.) of the can surface may attain the desired curing temperature in a minimum or desirable amount of time. In some cases, the amount of time needed for curing may be referred to as the dwell time. The dwell time may depend on the curing temperature, oven temperature, etc., in some cases. Aspects of the present disclosure may also relate to minimizing the dwell time while ensuring for an adequate quality of the cured coatings.

In one particular embodiment, the base of each can may be held in a rotatable seat attached to the conveyance mechanism such that the circumference of the rotatable seat is in continuous contact with a fixed rail or other surface and is continuously rotated as the can is conveyed through the oven, as previously described in relation to FIGS. 4A-B. In another particular embodiment, the base of each can may be held in a rotatable seat attached to the conveyance mechanism such that the circumference of the rotatable seat consists of a geared cog that makes intermittent contact with protrusions incorporated into a fixed rail or other surface and thereby rotates by a fixed angle each time the cog makes contact with one of the fixed protrusions as the can is conveyed through the oven, also described in relation to FIGS. 4A-B.

In other embodiments, multiple infrared heat sources (e.g., infrared heat sources 518-a and 518-b in FIGS. 5B and 5C) may be oriented at different angles or locations relative to the can path to optimize the amount of can surface area being radiated by the heat sources (i.e., as compared to when the heat sources are oriented in the same direction along the can path). In a particular embodiment, infrared heat sources may be linearly arrayed on two or more sides of the can path, such that heat is radiated primarily in directions that are perpendicular to the can path. In another particular embodiment, infrared heat sources may be arrayed in a zig-zag pattern on one or more sides of the can path such that the primary direction of the heat radiated from a given heat source is angularly offset, for example, by thirty or ninety degrees, relative to the primary direction of the heat radiated from an adjacent heat source. This may serve to effectively increase the total irradiated surface area of the can at any given time, compared to the surface area that is irradiated when all of the heat sources are similarly aligned.

In some embodiments, the curing oven may be a forced convection oven configured to continuously move hot air over the surface of the can for increased heat transfer. In some aspects, continuous movement of hot air may also allow for more uniform temperatures amongst the cans. In some other cases, the curing oven may be a forced convection continuous conveyor oven utilizing a perforated fiberglass conveyor mat. The use of a perforated mat may allow for air flow through the mat, thus enabling the can(s) to be cured without displacing them.

As noted in FIGS. 4A-B and 5A-C, curing duration and temperature may vary depending on the specific primer, obscurant or overvarnish (or adapted overvarnish) and/or the curing oven (i.e., forced convection oven, forced convection continuous conveyor oven, arrangement of heat sources, etc.) being used. Additionally or alternatively, oven set point temperature and time spent in the oven by the can may vary depending on the specific obscurant or adapted overvarnish and curing oven used. In some embodiments, cans loaded into the curing oven may remain in a fixed position (or stationary) during the curing process. In other cases, the curing oven may comprise a conveyance mechanism for transporting the cans through the oven. In either case, a controlled and specific temperature may be used to cure the obscurant coating (e.g., if obscurant layer(s) are cured following application, and before application of second decoration or ink layer) and/or previously applied second overvarnish layer on the surface of the can. In some cases, the time spent in the curing oven may be referred to as the residence time. The residence time may be based on a variety of factors, including but not limited to, the speed of the conveyance mechanism (if any) and the curing temperature. The residence time of the can in the curing oven may be controlled by a timer and/or via adjustment of the conveyor speed. In this way, the obscurant coating and/or second overvarnish coating of the can may be exposed to the required curing temperature for the required amount of time, thus allowing it to set on the curvilinear side surface of the can. In some cases, a can may comprise different curing zones, each associated with a different curing temperature or residence time. In such cases, the curing oven may be configured to apply different levels of heat to different curing zones of the can, as well as vary the heat exposure time for different curing zones. As an example, if the curing temperature for the neck of a can is determined to be higher than the bottom third of the can, and the residence time for the neck is 2 minutes longer than for the bottom third of the can, the curing oven may be configured to vary its conveyor speed, distance between a heat source and a respective curing zone of the can, and/or a power level of the infrared heat sources to ensure that the different curing zones receive an appropriate amount of heat for an appropriate amounts of time (i.e., in order to achieve a curvilinear surface temperature for a set time duration as required for curing of the obscurant or second overvarnish coating.). It should be noted that the curing conditions (e.g., temperature, time, rotation speed, if any, etc.) may be the same or different for the obscurant and the second overvarnish coating. Further, the type of curing oven (e.g., curing oven 400 in FIG. 4 or curing oven 500 in FIG. 5) used for the obscurant and the second overvarnish coating may also be different, in some embodiments. In other cases, the same curing oven may be used for curing both the obscurant and the second overvarnish.

In some cases, in order to avoid any over-curing of applied coatings (e.g., primers, obscurant, inks or varnishes), which may result in discoloration or adhesion issues, the temperature of the cans may be limited, such as below 390° F. In some cases, after leaving the curing oven, the cured can may be cooled (e.g., to room temperature) and transferred to a medium for delivery to the customer, such as a shipping pallet via a palletizer or a cardboard carton via an accumulation table.

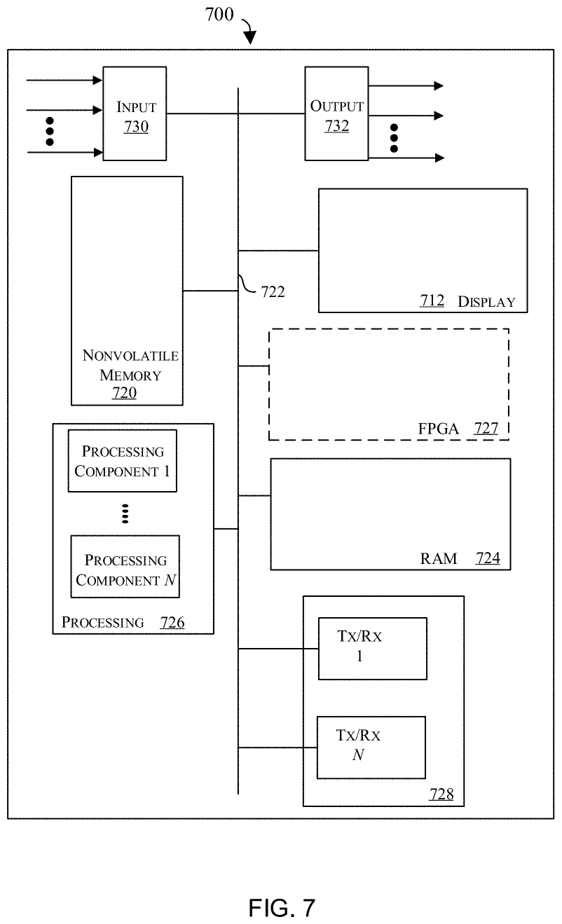

The methods described in connection with the embodiments disclosed herein may be embodied directly in hardware, in processor-executable code encoded in a non-transitory tangible processor readable storage medium, or in a combination of the two. Referring to FIG. 7 for example, shown is a block diagram 700 depicting physical components that may be utilized to realize the controller (e.g., controller 417 in FIG. 4) according to an exemplary embodiment. As shown, in this embodiment a display portion 712 and nonvolatile memory 720 are coupled to a bus 722 that is also coupled to random access memory (“RAM”) 724, a processing portion (which includes N processing components) 726, an optional field programmable gate array (FPGA) 727, and a transceiver component 728 that includes N transceivers. Although the components depicted in FIG. 7 represent physical components, FIG. 7 is not intended to be a detailed hardware diagram; thus many of the components depicted in FIG. 7 may be realized by common constructs or distributed among additional physical components. Moreover, it is contemplated that other existing and yet-to-be developed physical components and architectures may be utilized to implement the functional components described with reference to FIG. 7.

This display portion 712 generally operates to provide a user interface for a user, and in several implementations, the display is realized by a touchscreen display. In general, the nonvolatile memory 720 is non-transitory memory that functions to store (e.g., persistently store) data and processor-executable code (including executable code that is associated with effectuating the methods described herein). In some embodiments for example, the nonvolatile memory 720 includes bootloader code, operating system code, file system code, and non-transitory processor-executable code to facilitate the execution of a method described with reference to FIGS. 1 and/or 6 described further herein.

In many implementations, the nonvolatile memory 720 is realized by flash memory (e.g., NAND or ONENAND memory), but it is contemplated that other memory types may be utilized as well. Although it may be possible to execute the code from the nonvolatile memory 720, the executable code in the nonvolatile memory is typically loaded into RAM 724 and executed by one or more of the N processing components in the processing portion 726.

The N processing components in connection with RAM 724 generally operate to execute the instructions stored in nonvolatile memory 720 to enable control of a surface treatment system, obscurant spray and cure system, overvarnish spray system, and/or curing oven. For example, non-transitory, processor-executable code to effectuate the methods described with reference to FIGS. 1 and/or 6 may be persistently stored in nonvolatile memory 720 and executed by the N processing components in connection with RAM 724. As one of ordinarily skill in the art will appreciate, the processing portion 726 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 726 may be configured to effectuate one or more aspects of the methodologies described herein (e.g., the method described with reference to FIG. 1 or FIG. 6). For example, non-transitory processor-readable instructions may be stored in the nonvolatile memory 720 or in RAM 724 and when executed on the processing portion 726, cause the processing portion 726 to perform a method of redecorating a previously decorated and optionally overvarnished can. Alternatively, non-transitory FPGA-configuration-instructions may be persistently stored in nonvolatile memory 720 and accessed by the processing portion 726 (e.g., during boot up) to configure the hardware-configurable portions of the processing portion 726 to effectuate the functions of the controller 110.

The input component 730 operates to receive signals (e.g., data from thermal sensors in the curing oven, data from conveyance mechanism in the curing oven, data from primer, obscurant or overvarnish spray system, data from obscurant/ink printer, etc.) that are indicative of one or more aspects related to the obscuration and potential redecoration of a previously decorated and overvarnished can. The signals received at the input component may include, for example, temperature data, speed data, coating thickness data, to name a few non-limiting examples. The output component generally operates to provide one or more analog or digital signals to effectuate an operational aspect of the controller, such as controller 417 in FIG. 4A. For example, the output portion 732 may provide the controller instructions to vary a linear or rotational speed of the conveyance mechanism 401 described with reference to FIG. 1.

The depicted transceiver component 728 includes N transceiver chains, which may be used for communicating with external devices via wireless or wireline networks. Each of the N transceiver chains may represent a transceiver associated with a particular communication scheme (e.g., Wi-Fi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for decorating a previously overvarnished can, comprising:
providing a can, the can comprising:
a base;
a curvilinear side surface, the curvilinear side surface extending in an upward direction from the base and comprising a neck and flanged portion, and wherein the base and curvilinear side surface are formed using a metallic material; and
at least one first ink layer applied on at least a portion of the curvilinear side surface;
at least one layer of a first overvarnish applied over the first ink layer, wherein the at least one layer of the first overvarnish is applied on at least the curvilinear side surface;
applying one or more layers of an optically dense obscurant coating to the portion of the curvilinear side surface of the can, such that the one or more layers of the optically dense obscurant coating partially obscure at least a portion of color, text or graphical elements of the at least one first ink layer and reduces its legibility; and
curing, via a curing oven or via exposure to a UV or other energy source, the can.

2. The method of claim 1, wherein the one or more layers of the optically dense obscurant coating fully obscure the color, text or graphical elements of the at least one first ink layer.

3. The method of claim 1, wherein the one or more layers of the optically dense obscurant coating comprise one or more of ultraviolet (UV) curable or non-UV curable ink, paint, pigmented varnish or pigmented water-soluble overvarnish, and lubricants to provide a low-friction surface.

4. The method of claim 3, wherein the one or more layers of the optically dense obscurant coating comprise one or more metallic particles

5. The method of claim 4, wherein the one or more metallic particles comprise one or more of aluminum and aluminum oxide.

6. The method of claim 3, wherein the one or more layers of the obscurant coating are applied using one or more of a digital printer, spraying machine, one or more offset rollers, a conformable profiled roller, and via dipping or submerging the can into the obscurant coating.

7. The method of claim 6, wherein the spraying machine comprises one or more of spray guns, nozzles, nozzle filters, nozzle restrictors, pressure sensors, viscosity sensors, and temperature sensors, and wherein the spraying machine is electronically and communicatively coupled to a controller.

8. The method of claim 1, further comprising:
surface treating the curvilinear side surface of the can to increase a surface energy of the at least one layer of the first overvarnish.

9. The method of claim 8, wherein surface treating comprises modifying a topography and chemistry of the curvilinear side surface of the can and wherein the surface treating is selected from a group consisting of a blown ion surface treatment, detergent washing, corona treatment, chemical etching, chemical plasma treatment, flame treatment, application of primer materials, and laser surface treatment.

10. The method of claim 9, wherein the blown ion surface treatment comprises utilizing one or more ion treater heads, wherein each ion treater head comprises one or more nozzles including coaxial electrodes, the method further comprising: blowing compressed air through at least a portion of nozzles of the one or more ion treater heads to cause one or more ion or plasma plumes to extend from at least the portion of nozzles via interaction of the compressed air with respective coaxial electrodes, and wherein the one or more ion or plasma plumes contact the curvilinear side surface of the can to increase the surface energy of the at least one layer of the first overvarnish.

11. The method of claim 1, wherein the one or more layers of the obscurant coating applied to the can are thermally cured by a continuous or intermittent heat source during the application of the obscurant coating and/or subsequently in the curing oven.

11. The method of claim 1, wherein the one or more layers of the obscurant coating applied to the can are cured by exposure to a UV or other energy source during the application of the obscurant coating and/or following the application of the obscurant coating.

12. The method of claim 11, wherein the curing oven comprises a conveyance mechanism for transporting the can through the curing oven.

13. The method of claim 12, wherein curing the can via the curing oven further comprises: determining a curing temperature for the can, the curing temperature based in part on the obscurant coating, and the method further comprising: determining a residence time for curing the can, wherein a speed of the conveyance mechanism is based in part on the curing temperature, the residence time, or a combination thereof.

14. The method of claim 1, further comprising:
applying one or more second ink layers to the portion of the curvilinear side surface of the can, wherein the portion may or may not include at least the neck and flanged portion.

15. The method of claim 14, wherein the one or more second ink layers are applied via a digital inkjet printer.

16. The method of claim 1, further comprising:
applying one or more layers of a second overvarnish to the portion of the curvilinear side surface of the can, wherein the one or more layers of the second overvarnish comprise outermost layers of the portion.

17. The method of claim 16, wherein the second overvarnish is one of water-soluble, non-ultraviolet (UV) curable, water-soluble and non-UV curable, or UV curable.

18. The method of claim 17, wherein the one or more layers of the second overvarnish are applied using one or more of a digital printer, spraying machine, one or more offset rollers, a conformable profiled roller, and via dipping or submerging the can into the second overvarnish.

19. The method of claim 18, wherein the spraying machine comprises one or more spray guns, nozzles, nozzle filters, nozzle restrictors, pressure sensors, viscosity sensors, temperature sensors, heaters, and forced air applicators and wherein the spraying machine is electronically and communicatively coupled to a controller.

20. The method of claim 19, wherein the controller is configured to pass instructions to the spraying machine dictating one or more adjustable parameters, the one or more adjustable parameters selected from a group consisting of a number of spray guns, nozzle types, nozzle orientations, nozzle filter type, nozzle restrictor type, programmable spray times, nozzle rotational speed, can rotational speed, nozzle spray pressures, distance between adjacent nozzle tips and a surface of the can, second overvarnish temperature, obscurant viscosity, second overvarnish viscosity, ambient temperature, can orientation, can temperature, humidity, velocity and temperature of a forced-air cure accelerant.

21. The method of claim 20, wherein the second overvarnish is adapted prior to being applied to the portion of the curvilinear side surface of the can, the adapting comprising: diluting the second overvarnish using a solvent to produce an overvarnish-solvent mixture; heating and stirring the overvarnish-solvent mixture to produce an adapted overvarnish mixture; and storing the adapted overvarnish mixture in a reservoir, wherein the reservoir is maintained within a threshold temperature range.

22. The method of claim 21, wherein the solvent is one of distilled or deionized water, and wherein the reservoir is a heated reservoir.

23. The method of claim 21, further comprising: supplying, via a hydraulic pump and one or more pressure regulators of the spraying machine, the adapted overvarnish mixture from the reservoir to one or more spray heads of a spraying machine.

24. The method of claim 23, wherein applying the one or more layers of second overvarnish comprises applying one or more layers of the adapted overvarnish mixture, and wherein applying the one or more layers of the adapted overvarnish mixture further comprises: transferring the can comprising one or more second ink layers to a rotatable chuck, the rotatable chuck adapted to hold and axially rotate the can; and spraying, using the one or more spray heads of the spraying machine, the adapted overvarnish mixture on the portion of the curvilinear side surface of the can.

25. The method of claim 16, wherein the one or more layers of the second overvarnish applied to the can are thermally cured in the curing oven, and wherein the curing oven comprises a conveyance mechanism for transporting the can through the curing oven.

26. The method of claim 25, wherein curing the can via the curing oven further comprises: determining a curing temperature for the can, the curing temperature based in part on the second overvarnish; and determining a residence time for curing the can, wherein a speed of the conveyance mechanism is based in part on the curing temperature, the residence time, or a combination thereof.

27. A beverage can, comprising: a base; a curvilinear side surface extending in an upward direction from the base, the curvilinear side surface comprising a neck and flanged portion, and wherein the base and curvilinear side surface are formed using a metallic material; a first layer of ink applied on at least a first portion of the curvilinear side surface; a first overvarnish layer applied on at least the curvilinear side surface and over the first layer of ink; one or more layers of an obscurant coating applied on at least the first portion of the curvilinear side surface such that the one or more layers of the obscurant coating obscure at least a portion of color, text or graphical elements of the first layer of ink and reduce its legibility.

28. The beverage can of claim 27, further comprising:
one or more layers of a second ink applied to at least a second portion of the curvilinear side surface of the can, and over the one or more layers of the obscurant coating; and
one or more layers of a second overvarnish applied to at least the second portion of the curvilinear side surface of the can such that the one or more layers of the second overvarnish comprise outermost layers of the curvilinear side surface of the can; and curing, via a curing oven or a UV or other energy source, the can.

29. The beverage can of claim 28, wherein one or more layers of the obscurant coating layers are formed on at least the first portion of the curvilinear side surface, wherein the first portion may or may not include the neck and flanged portion, and wherein the one or more layers of the obscurant coating are formed after surface treating the curvilinear side surface of the can, and wherein the surface treating causes an increase in surface energy of the first overvarnish layer.

30. A system for decorating a previously overvarnished and decorated can, the system comprising:
the can, the can comprising:
a base;
a curvilinear side surface, the curvilinear side surface extending in an upward direction from the base and comprising a neck and flanged portion, and
wherein the base and curvilinear side surface are formed using a metallic material; and
at least one layer each of a first ink and a first overvarnish applied on at least
a portion of the curvilinear side surface;
a surface treatment device;
a printing device;
a spraying device;
a curing oven or a UV or other energy source for curing;
and one or more hardware processors configured by machine-readable instructions to: surface treat, by the surface treatment device, at least the curvilinear side surface of the can to increase a surface energy of the at least one layer of the first overvarnish;
apply, by the printing device, one or more layers of an obscurant coating to the portion of the curvilinear side surface of the can, wherein the portion may or may not include the neck and flanged portion;
apply, by the printing device, one or more layers of a second ink to the curvilinear side surface of the can;
apply, by the spraying device, one or more layers of a second overvarnish to the curvilinear side surface of the can; and
cure, by the curing oven or other energy source, the one or more layers of the second overvarnish.

31. A method for decorating a previously overvarnished can, comprising:
providing a can, the can comprising:
a base;
a neck and flanged portion;
a curvilinear side surface, the curvilinear side surface extending in an upward direction from the base, wherein the base and curvilinear side surface are formed using a metallic material; and
at least one first ink layer applied on at least a portion of the curvilinear side surface, the base, the neck and flanged portion, or a combination;
at least one layer of a first overvarnish applied over the first ink layer;
surface treating the portion of the can to remove all or most of the at least one layer of the first overvarnish, the at least one first ink layer, or a combination;
applying one or more second ink layers to the portion of the curvilinear side surface of the can, wherein the portion may or may not include the neck and flanged portion;
applying one or more layers of a second overvarnish to the portion of the curvilinear side surface of the can, wherein the one or more layers of the second overvarnish comprise outermost layers on the can;
and
curing, via a curing oven or other energy source, the can.
